(19) United States
(12) Patent Application Publication
(10) Pub. No.: US 2024/0381058 A1
(43) Pub. Date: Nov. 14, 2024

(54) METHOD AND APPARATUS FOR SUPPORTING AD HOC GROUP STANDALONE SHORT DATA SERVICES IN A WIRELESS COMMUNICATION SYSTEM

(71) Applicant: Samsung Electronics Co., Ltd., Gyeonggi-do (KR)

(72) Inventors: Kiran Gurudev KAPALE, Bangalore (IN); Arun Prasath RAMAMOORTHY, Bangalore (IN)

(21) Appl. No.: 18/663,277

(22) Filed: May 14, 2024

(30) Foreign Application Priority Data
May 14, 2023 (IN) 202341033841
Aug. 14, 2023 (IN) 202341054681
Apr. 29, 2024 (IN) 202341033841

(51) Int. Cl. H04W 4/08; H04W 84/18

(52) U.S. Cl. CPC H04W 4/08; H04W 84/18

(57) ABSTRACT

The disclosure relates to a 5G or 6G communication system for supporting a higher data transmission rate. Specifically, the disclosure related to apparatus and methods for supporting ad hoc group standalone SDS in MCData service. A method incudes receiving, by MCData server of primary MCData system, first data transfer request message from MCData client of primary MCData system for determining target MCData users for standalone SDS. Further, determines whether criteria for determining a list of MCData users or a list of MCData users associated with primary and partner MCData system is received. Further, determining list of MCData users based on criteria when criteria is received, and creates an ad hoc group, assigns pre-configured group and ad hoc group ID. Also, creating an ad hoc group based on list of MCData users associated with primary and partner MCData system when list of MCData users are received in first data transfer request message, and assigning a pre-configured group and ad hoc group ID to created ad hoc group.

### CROSS-REFERENCE TO RELATED APPLICATION(S)

This application is based on and claims priority under 35 U.S.C. § 119 to Indian Provisional Patent Application Nos. 20/2341033841 and 202341054681, which were filed in the Indian Patent Office on May 14, 2023, and Aug. 14, 2023, respectively, and to Indian patent application No. 202341033841, which was filed in the Indian Patent Office on Apr. 29, 2024, the entire content of each of which is incorporated herein by reference.

### BACKGROUND

### 1. Field

The disclosure relates generally to a telecommunication network system, and more particularly, to systems and methods supporting ad hoc group standalone short data services (SDSs) in a mission critical data (MCData) service.

### 2. Description of Related Art

5^{th} generation (5G) mobile communication technologies define broad frequency bands such that high transmission rates and new services are possible, and can be implemented in “sub 6 GHz” bands such as 3.5 GHZ, and in “above 6 GHz” bands, which may be referred to as mm Wave, including 28 GHz and 39 GHz.

In addition, it has been considered to implement 6th generation (6G) mobile communication technologies (e.g., referred to as beyond 5G systems) in terahertz (THz) bands (e.g., 95 GHz to 3 THz bands) in order to achieve transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input, multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by newer 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN), which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of connected devices that will be connected to communication networks is expected to exponentially increase, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to support ad hoc group standalone SDSs in an MCData service.

Another aspect of the disclosure is to provide a mechanism through which an MCData user can initiate a standalone SDS to ad hoc group MCData users.

Another aspect of the disclosure is to provide an MCData service the support of ad hoc group SDS using a signaling control plane involving a single MCData system and/or multiple MCData systems, that are used by public safety communities (e.g., police, military, fire services, ambulance crews, etc.) and railways in regular operations that require high reliability, speed, quick accessibility and low latency operational support. This allows an MCData user to send short data to the Ad hoc group of MCData users.

In accordance with an aspect of the disclosure, a method is provided for supporting an ad hoc group standalone SDS in an MCData service. The method includes receiving, by an MCData server of a primary MCData system, a first data transfer request message from an MCData user at an MCData client of the primary MCData system for determining target MCData users for the ad hoc group standalone SDS; determining, by the MCData server of the primary MCData system, whether a criteria for determining a list of MCData users or a list of MCData users associated with the at least one of the primary MCData system or a partner MCData system is received in the first data transfer request message; in response to determining that the criteria for determining the list of the MCData users is received in the first data transfer request message, determining, by the MCData server, the list of MCData users based on the criteria, creating an ad hoc group based on the determined list of the MCData users; in response to determining that the list of the MCData users associated with the at least one of the primary MCData system or the partner MCData system is received in the first data transfer request message, creating, by the MCData server, the ad hoc group based on the list of the MCData users associated with the at least one of the primary MCData system or the partner MCData system; assigning a pre-configured group to use a configuration for the ad hoc group; and assigning an ad hoc group identifier (ID) to the ad hoc group.

In accordance with another aspect of the disclosure, a method is provided for supporting an ad hoc group standalone SDS in an MCData service. The method includes initiating, by an MCData user at an MCData client of a primary MCData system, the ad hoc group standalone SDS; transmitting, by the MCData user at the MCData client of the primary MCData system, a first data transfer request message to an MCData server of the primary MCData system for determining target MCData users for the ad hoc group standalone SDS; and receiving, by the MCData client of the primary MCData system, a first response message from the MCData server of the primary MCData system for performing the ad hoc group standalone SDS.

In accordance with another aspect of the disclosure, an MCData server is provided for a primary MCData system for supporting an ad hoc group standalone SDS in an MCData service. The MCData server includes a processor; and an SDS controller configured to receive a first data transfer request message from an MCData user at an MCData client of the primary MCData system for determining target MCData users for the ad hoc group standalone SDS, determine whether a criteria for determining a list of MCData users or a list of MCData users associated with the at least one of the primary MCData system or a partner MCData system is received in the first data transfer request message, in response to determining that the criteria for determining the list of the MCData users is received in the first data transfer request message, determine the list of MCData users based on the criteria, and create an ad hoc group based on the determined list of the MCData users, in response to determining that the list of the MCData users associated with the at least one of the primary MCData system or the partner MCData system is received in the first data transfer request message, create the ad hoc group based on the list of the MCData users associated with the at least one of the primary MCData system or the partner MCData system, assign a pre-configured group to use a configuration for the ad hoc group, and assign an ad hoc group ID to the ad hoc group.

In accordance with another aspect of the disclosure, an MCData client is provided for a primary MCData system for supporting an ad hoc group standalone SDS in an MCData service. The MCData client includes a processor; and an SDS controller configured to initiate the ad hoc group standalone SDS, transmit a first data transfer request message to an MCData server of the primary MCData system for determining target MCData users for the ad hoc group standalone SDS, and receive a first response message from the MCData server of the primary MCData system for performing the ad hoc group standalone SDS.

### BRIEF DESCRIPTION OF THE DRAWINGS

The above and other features, aspects, and advantages of certain embodiment of the disclosure will be more apparent from the following detailed description taken in conjunction with the accompanying drawings, in which:

FIG. 1A illustrates an interaction between a primary MCData system and a partner MCData system for supporting an ad hoc group SDS in MCData servers, according to an embodiment;

FIG. 1B illustrates an MCData server for supporting an ad hoc group SDS, according to an embodiment;

FIG. 1C illustrates an MCData client for supporting an ad hoc group SDS, according to an embodiment;

FIG. 2A is a signal flow diagram illustrating an ad hoc group standalone data transfer request to determine an ad hoc group and a preconfigured group for end-to-end encryption, according to an embodiment;

FIG. 2B is a signal flow diagram illustrating an ad hoc group standalone SDS using an MCData user list provided by an initiator involving a single MCData system, according to an embodiment;

FIG. 2C is a signal flow diagram illustrating an ad hoc group standalone SDS using an MCData user list provided by an MCData server involving a single MCData system, according to an embodiment;

FIG. 2D is a signal flow diagram illustrating an ad hoc group standalone SDS using an MCData user list provided by an initiator involving multiple MCData systems, according to an embodiment;

FIG. 2E is a signal flow diagram illustrating an ad hoc group standalone SDS using an MCData user list provided by an MCData server involving multiple MCData systems, according to an embodiment;

FIG. 3A is a signal flow diagram illustrating an ad hoc group standalone SDS using an MCData user list provided by an initiator involving a single MCData system, according to an embodiment;

FIG. 3B is a signal flow diagram illustrating an ad hoc group standalone SDS using an MCData user list provided by an MCData server involving a single MCData system, according to an embodiment;

FIG. 3C is a signal flow diagram illustrating an ad hoc group standalone SDS using end-to-end encryption involving a single MCData system, according to an embodiment;

FIG. 3D is a signal flow diagram illustrating an ad hoc group standalone SDS using an MCData user list provided by an initiator involving multiple MCData systems, according to an embodiment;

FIG. 3E is a signal flow diagram illustrating an ad hoc group standalone SDS using an MCData user list provided by an MCData server involving multiple MCData systems, according to an embodiment;

FIG. 3F is a signal flow diagram illustrating an ad hoc group standalone SDS using end-to-end encryption involving multiple MCData systems, according to an embodiment;

FIG. 4A is a signal flow diagram illustrating an ad hoc group standalone SDS using an MCData ad hoc group involving a single MCData system, according to an embodiment;

FIG. 4B is a signal flow diagram illustrating an ad hoc group standalone SDS using an MCData ad hoc group involving multiple MCData systems, according to an embodiment;

FIG. 5 is a signal flow diagram illustrating an ad hoc group standalone SDS using an MCData user list provided by an initiator involving a single MCData system, according to an embodiment;

FIG. 6 is a signal flow diagram illustrating an ad hoc group standalone SDS using an MCData user list provided by an MCData server involving a single MCData system, according to an embodiment;

FIG. 7 is a signal flow diagram illustrating an ad hoc group standalone SDS using an MCData user list provided by an initiator involving multiple MCData systems, according to an embodiment;

FIG. 8 is a signal flow diagram illustrating an ad hoc group standalone SDS using an MCData user list provided by an MCData server involving multiple MCData systems, according to an embodiment;

FIG. 9A is a flow chart illustrating a method for supporting an ad hoc group standalone SDS in an MCData service by an MCData server of an MCData primary system, according to an embodiment; and

FIG. 9B is a flow chart illustrating a method for supporting an ad hoc group standalone SDS in an MCData service by an MCData client of an MCData primary system, according to an embodiment.

### DETAILED DESCRIPTION

Various embodiments of the disclosure and various features and advantageous details thereof are explained more fully below with reference to the accompanying drawings and detailed in the following description.

Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments.

The term “or” as used herein, refers to a non-exclusive or, unless otherwise indicated.

Examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components, etc., are physically implemented by analog and/or digital circuits such as logic gates, integrated circuits (ICs), microprocessors, microcontrollers, memory circuits, passive electronic components, active electronic components, optical components, hardwired circuits, etc., and optionally be driven by firmware and software. The circuits, e.g., may be embodied in one or more semiconductor chips, or on substrate supports such as printed circuit boards (PCBs) and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings.

To the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

As such, proposed methods are construed to extend to any alterations, equivalents and substitutes in addition to those which are particularly set out in the accompanying drawings.

Although numerical terms such as first, second, etc., may be used herein to describe various elements, these elements are not be limited by these terms. That is, these terms are generally used to distinguish one element from another.

In accordance with an embodiment of the disclosure, for mission critical services for public safety and railways, provided is an ad hoc group standalone SDS using signaling control plane support, based on criteria shared by an MCData user and participants determined by the MCData server using shared criteria or a participant list shared by the MCData user. The ad hoc group standalone SDS using signaling control plane support involves MCData users from a single MCData system or multiple MCData systems. A primary MCData system of an initiating MCData user is generally responsible for handling the ad hoc group standalone SDS. The initiating MCData user can provide the list of MCData users or criteria to determine the MCData users. When the criteria is provided by the MCData user, the primary MCData system determines the MCData users based on the criteria.

When any of the partner MCData systems are to be involved based on an agreement and criteria for determining the MCData users, then all of the involved partner MCData systems should provide the list of MCData users who meet the criteria from their MCData system only one time. The list of MCData user provided by initiating MCData user may contain the MCData users from partner system. The ad hoc group may then be formed using determined/supplied list of MCData users and pre-configured MCData group is assigned to use the configurations from it (e.g., security materials). The primary MCData system returns the list of MCData users, an ad hoc group identifier (ID), and a pre-configured MCData group for the configuration to be applied to the initiating MCData user. The initiating MCData user re-initiates the ad hoc group standalone SDS using a signaling control plane with the ad hoc group ID and the pre-configured MCData group. Once the ad hoc group standalone SDS using the signaling control plane is completed, then the ad hoc group is deleted from the MCData server. The deleting of ad hoc group can consider any local policies defined in the MCData system.

An existing specification TS 23.282 supports cases in which an MCData user is initiating a one-to-one or group standalone SDS using a signaling control plane for sending standalone SDS data to another MCData user or an MCData group.

In the mission critical services for public safety and railways, some situations requires the sending of standalone SDS data to the ad hoc group of MCData users, which are determined and combined to form an ad hoc group based on policies, criteria, and any other relevant conditions.

In accordance with an embodiment of the disclosure, a method is provided for supporting an ad hoc group standalone SDS in an MCData service. The method includes receiving, by an MCData server of a primary MCData system, a first data transfer request message, from an MCData user at an MCData client of the primary MCData system, for determining target MCData users for the ad hoc group standalone SDS. Further, the method includes determining, by the MCData server of the primary MCData system, whether a criteria for determining a list of MCData users or a list of MCData users associated with the at least one of the primary MCData system or a partner MCData system is received in the first data transfer request message. Further, the method includes determining the list of MCData users based on the criteria when the criteria is received in the first data transfer request message, and creating an ad hoc group based on the determined list of MCData users, and assigning a pre-configured group to use a configuration for the created ad hoc group and assigning an ad hoc group ID to the created ad hoc group. Also, the method includes creating an ad hoc group based on the list of MCData users associated with the at least one of the primary MCData system or the partner MCData system when the list of MCData users are received in the first data transfer request message, and assigning a pre-configured group to use a configuration for the created ad hoc group and assigning an ad hoc group ID to the created ad hoc group.

In accordance with an embodiment of the disclosure, a method is provided for supporting an ad hoc group standalone SDS in an MCData service. The method includes initiating, by an MCData user at an MCData client of a primary MCData system, an ad hoc standalone SDS. Further, the method includes transmitting, by the MCData user at the MCData client of the primary MCData system, a first data transfer request message to an MCData server of the primary MCData system for determining target MCData users for the ad hoc standalone SDS. Further, the method includes receiving, by the MCData client of the primary MCData system, a first response message from the MCData server of the primary MCData system for performing the ad hoc standalone SDS.

In accordance with an embodiment of the disclosure, an MCData server of a primary MCData system is provided for supporting an ad hoc group standalone SDS in an MCData service. The MCData server of the primary MCData system includes a processor and an SDS controller coupled to the processor. The SDS controller is configured to receive a first data transfer request message from an MCData user at an MCData client of the primary MCData system for determining target MCData users for the ad hoc group standalone SDS. Further, the SDS controller determines whether a criteria for determining a list of MCData users or a list of MCData users associated with at least one of the primary MCData system or a partner MCData system is received in the first data transfer request message. Further, the SDS controller determines the list of MCData users based on the criteria, when the criteria is received in the first data transfer request message, creates an ad hoc group based on the determined list of MCData users, and assigns a pre-configured group to use a configuration for the created ad hoc group and assigns ad hoc group ID to the created ad hoc group. Also, the SDS controller creates an ad hoc group based on the list of MCData users associated with the at least one of the primary MCData system or the partner MCData system, when the list of MCData users is received in the first data transfer request message, and assigns a pre-configured group to use a configuration for the created ad hoc group and assigns an ad hoc group ID to the created ad hoc group.

In accordance with an embodiment of the disclosure, an MCData client of a primary MCData system is provided for supporting an ad hoc group standalone SDS in an MCData service. The MCData client of the primary MCData system includes a processor and an SDS controller communicatively coupled to the processor. The SDS controller is configured to initiate an ad hoc standalone SDS. Further, the SDS controller transmits a first data transfer request message to an MCData server of the primary MCData system for determining target MCData users for the ad hoc group standalone SDS. Further, the SDS controller receives a first response message from the MCData server of the primary MCData system for performing the ad hoc group standalone SDS.

In accordance with above-described embodiments, methods are provided for an MCData service with an ad hoc group SDS using a signaling control plane involving a single MCData system and/or multiple MCData systems.

Also, an initiator MCData user may initiate a standalone SDS to an ad hoc group of MCData users. For example, standalone SDS data may be sent to an ad hoc group of MCData users determined and combined to form an ad hoc group based on policies and criteria.

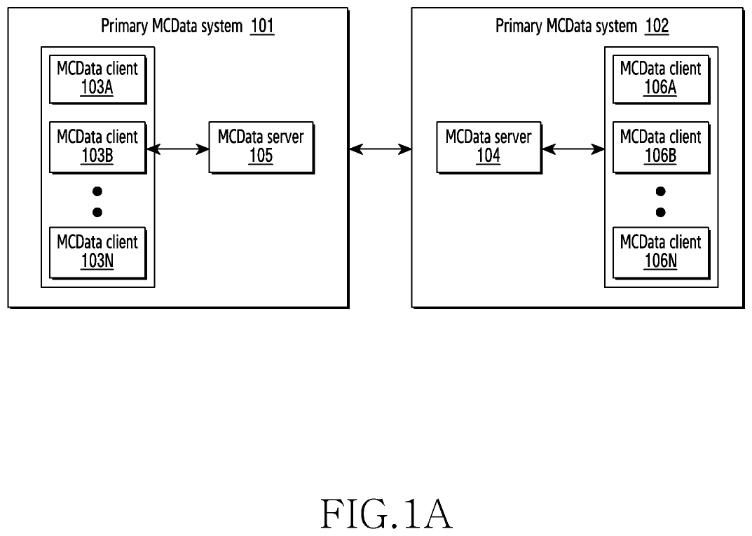

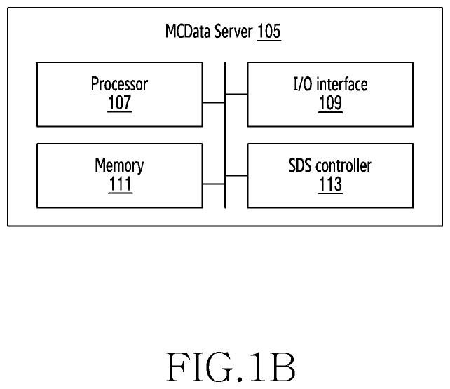

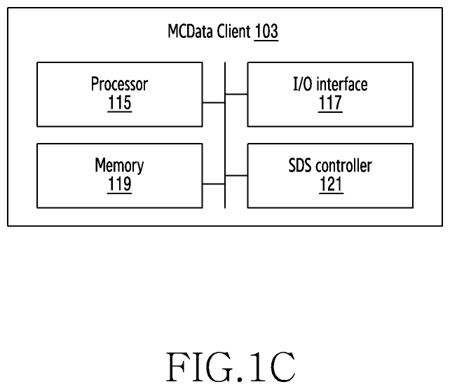

FIG. 1A illustrates an interaction between a primary MCData system and a partner MCData system for supporting an ad hoc group SDS in MCData servers, according to an embodiment.

Referring to FIG. 1A, a plurality of MCData systems are provided for performing an MCData service. An MCData system that is initiating the MCData service can be referred to as a primary MCData system 101, and an MCData system that is participating in the MCData service initiated by the primary MCData system 101 can be referred to as a partner MCData system 102. The partner MCData system 102 can be a neighboring system to the primary MCData system 101.

The primary MCData system 101 (or simply primary system) may include a telecommunication network system, a wireless communication system, and/or an ad hoc network.

The primary MCData system 101 includes one or more network devices configured to communicate with each other. The primary MCData system 101 includes MCData clients 103A-103N and an MCData server 105 that communicate with each other to perform network services. Each of the MCData clients 103A-103N can be associated with an MCData user. Particularly, the MCData clients 103A-103N (or MC user devices) and the MCData server 105 (or MCData network apparatus) may perform an MCData service. The MCData service may be used by public safety, railways, military operations, etc. The MCData clients 103A-103N can communicate with each other through the MCData server 105 for performing the mission critical services. The MCData clients 103A-103N can also communicate with one or more of MCData clients 106A-106N of the partner MCData system 102 (or simply partner system.

The partner MCData system 102 can be a neighboring system of the primary system 101. The partner MCData system 102 includes the MCData client 106A-106N and an MCData server 104.

FIG. 1B illustrates an MCData server for supporting an ad hoc group SDS, according to an embodiment.

Referring to FIG. 1B, an MCData sever 105 includes a processor 107, a memory 111, an input/output (I/O) interface 109, and an SDS controller 113. The MCData server 105 communicates with an MCData client for performing an SDS in MCData network. For example, the MCData server 105 can include, but is not limited to a base station access point, a central server, or similar equipment.

The processor 107 of the MCData server 105 communicates with the memory 111, the I/O interface 109, and the SDS controller 113. The processor 107 is configured to execute instructions stored in the memory 111 and to perform various processes. The processor 107 can include one or a plurality of processors, can be a general-purpose processor, such as a central processing unit (CPU), an application processor (AP), etc., a graphics-only processing unit such as a graphics processing unit (GPU), a visual processing unit (VPU), and/or an AI dedicated processor such as a neural processing unit (NPU).

Further, the memory 111 of the MCData server 105 includes storage locations to be addressable through the processor 107. The memory 111 is not limited to a volatile memory and/or a non-volatile memory. The memory 111 can include one or more computer-readable storage media. The memory 111 can include non-volatile storage elements, e.g., magnetic hard discs, optical discs, floppy discs, flash memories, or forms of electrically programmable memories (EPROM) or electrically erasable and programmable (EEPROM) memories. The memory 111 of the MCData server 105 can store several information received from an MCData user device. For example, the memory 111 can store a list of MCData users, criteria for determining list of MCData users, etc. Also, the memory 111 can store data received in a first data transfer request message and in a second data transfer request message from MCData clients.

The I/O interface 109 transmits the information between the memory 111 and external peripheral devices. The peripheral devices are the input-output devices associated with the network apparatus. The I/O interface 109 receives several information from MCData clients, e.g., the list of MCData users, criteria for determining list of MCData users, etc.

The SDS controller 113 communicates with the I/O interface 109 and the memory 111 for supporting an ad hoc group standalone SDS in an MCData service. The SDS controller 113 is hardware that may be realized through physical implementation of both analog and digital circuits, including logic gates, integrated circuits, microprocessors, microcontrollers, memory circuits, passive and active electronic components, as well as optical components.

The SDS controller 113 of the MCData server 105 receives a first data transfer request message from an MCData user at an MCData client of a primary MCData system for determining target MCData users for the standalone SDS. Further, the SDS controller 113 determines whether the first data transfer request message includes a criteria for determining a list of MCData users at the MCData client associated with at least one of a primary MCData system or a partner MCData system. Further, the SDS controller 113 determines the list of MCData users based on criteria included in the first data transfer request message. The SDS controller 113 performs the determination of the list of MCData users when the criteria is included in the first data transfer request message. Upon determining the list of MCData users, the SDS controller 113 creates an ad hoc group based on the determined list of MCData users. Further, the SDS controller 113 assigns a pre-configured group to use the configuration for the created ad hoc group and also assigns an ad hoc group ID to the created ad hoc group.

Further, the SDS controller 113 only creates the ad hoc group based on the list of MCData users included in the first data transfer request message, when the list of MCData users are received in the first data transfer request message. The list of MCData users can be associated with at least one of the primary MCData system or the partner MCData system.

Further, the SDS controller 113 assigns the pre-configured group to use the configuration for the created ad hoc group and also assigns an ad hoc group ID to the created ad hoc group.

In an embodiment, the SDS controller 113 assigns the ad hoc group ID based on an ad hoc group ID received in the first data transfer request message. Additionally, the SDS controller 113 may generate a new ad hoc group ID when the ad hoc group ID is not received in the first data transfer request message or when the received ad hoc group ID is not acceptable by the SDS controller 113.

FIG. 1C illustrates an MCData client for supporting an ad hoc group SDS, according to an embodiment. For example, the MCData client illustrated in FIG. 1C may be one of the MCData clients 103A-103N illustrated in FIG. 1A.

Referring to FIG. 1C, the MCData client includes a processor 115, a memory 119, an I/O interface 117, and an SDS controller 121, which operate in a similar manner as the processor 107, the memory 111, the I/O interface 109, and the SDS controller 113 of the MCData server 105 described above. Accordingly, another description of these elements omitted here.

To determine an ad hoc group and a preconfigured group for end-to-end encryption the information flows as shown in Table 1 may be applied.

The Table 1 describes an information flow for an ad hoc group standalone data transfer request (or a first data transfer request message) sent from an MCData client to the MCData server 105.

TABLE 1

| | Sta- | |
|---|---|---|
| Information element | tus | Description |
| MCData ID | M | The identity of the MCData user |
| | | sending the request |
| Functional alias | O | The associated functional alias of |
| | | the MCData user sending request. |
| Encryption supported | M | Indicates whether this ad hoc group |
| | | data transfer support requires end- |
| | | to-end encryption |
| MCData ID list | O | MCData IDs for the ad hoc group |
| (see NOTE 1, NOTE 2) | | standalone SDS |
| Criteria for determining the | O | Carries the details of criteria or |
| participants (see NOTE 2) | | meaningful label identifying the |
| | | criteria or the combination of both |
| | | which will be used by the MCData |
| | | server for determining the list of |
| | | MCData users e.g., it can be a |
| | | location based criteria to SDS data |
| | | transfer in a particular area |
| Emergency indicator | O | Indicates that the data transfer |
| (see NOTE 3) | | request is for emergency ad hoc |
| | | group standalone SDS |
| Imminent peril indicator | O | Indicates that the data transfer |
| (see NOTE 3) | | request is for imminent peril ad hoc |
| | | group standalone SDS |
| identifier (see | | |
| Application identifier (see | O | Identifies the application for which |
| NOTE 4) | | the data payload is intended (e.g., |
| | | text string, port address, URI) |

NOTE 1:
This element is included only when the ad hoc group standalone SDS initiating client sends the list of MCData users.
NOTE 2:
Only one of these information elements is present.
NOTE 3:
If used, only one of these information elements shall be present.
NOTE 4:
The application identifier shall be included only if the data transfer is for application consumption.

Table 2 below describes an information flow of an ad hoc group standalone data transfer response (or a first data transfer response message) from the MCData server 105 to an MCData client. This response is to provide the server with an assigned MCData ad hoc group ID and a preconfigured group identity of preconfigured group from which the configurations to be used (e.g., security related information).

TABLE 2

| | Sta- | |
|---|---|---|
| Information Element | tus | Description |
| MCData ID | M | The identity of the MCData user sending |
| | | the request |
| MCData ad hoc group | M | The MCData group ID to be associated |
| ID | | with the ad hoc group standalone SDS |
| | | which is generated and assigned by the |
| | | MCData server. |
| Preconfigured MCData | O | Group identity whose configuration is to |
| group ID (see NOTE) | | be applied for ad hoc group standalone |
| | | SDS. |
| Result | M | Result of the ad hoc group standalone |
| | | data transfer (success or failure) |

NOTE:
If end-to-end encryption is required, then this element is included.

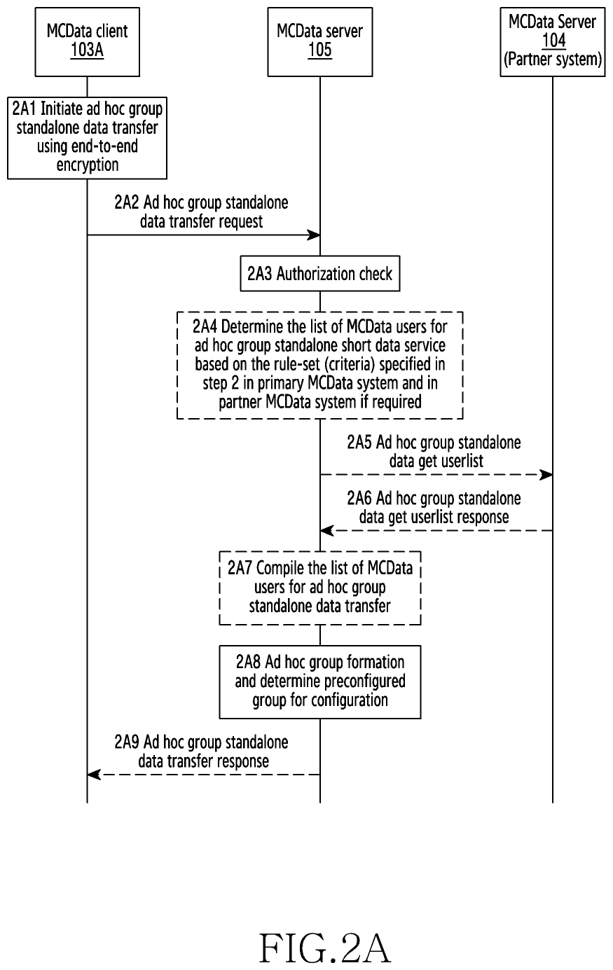

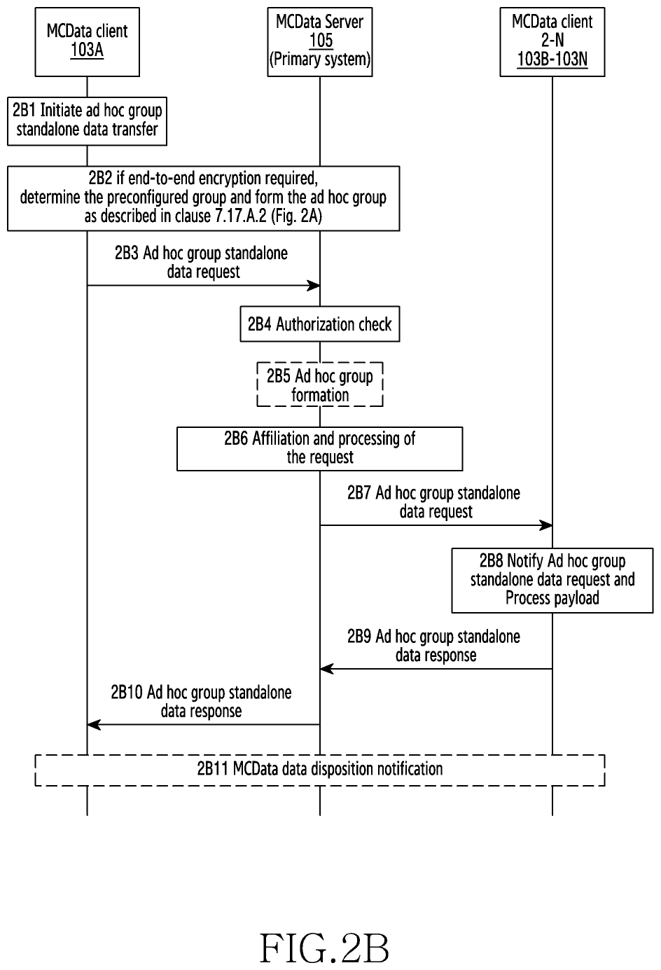

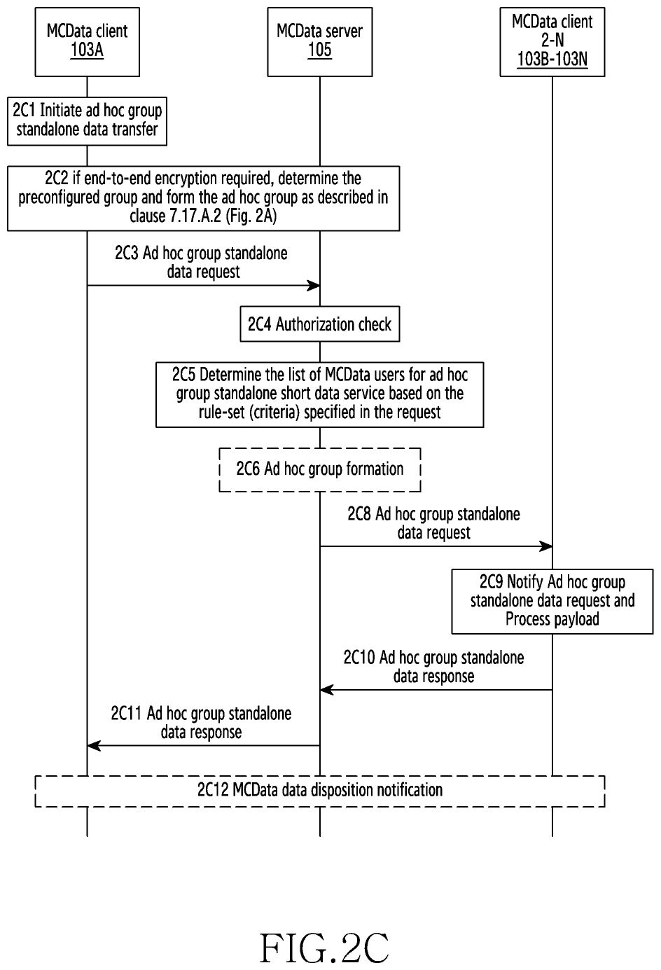

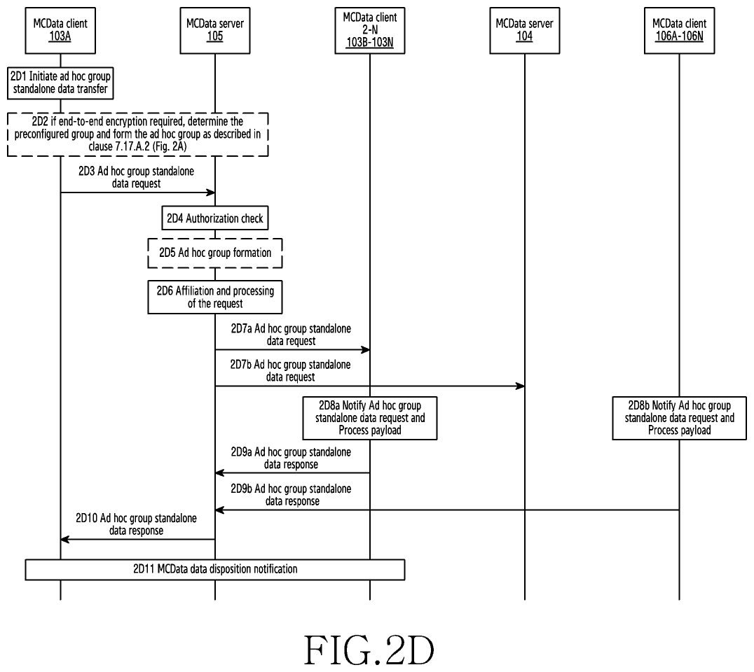

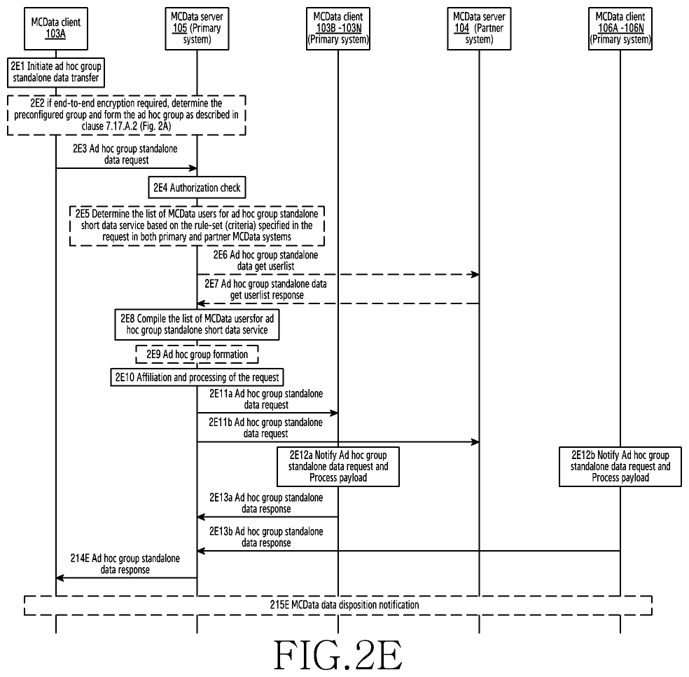

FIG. 2A is a signal flow diagram illustrating an ad hoc group standalone data transfer request to determine an ad hoc group and a preconfigured group for end-to-end encryption, according to an embodiment.

Referring to FIG. 2A, it is assumed that the MCData users belong to a primary MCData system and a partner MCData system and are already registered for receiving an MCData service. Further, an authorized MCData user at an MCData client 103A wants to invite MCData users for the ad hoc group standalone SDS either by providing a list of MCData users in a request or by providing certain criteria in the request to determine the MCData users who satisfy the certain criteria. Selection of MCData IDs of the ad hoc group members receiving the SDS data can be manual or from user profile configuration data or by any other means. The number of ad hoc group members receiving the SDS data should be within a configured limit.

In step 2A1, a user at the MCData client 103A wants to initiate an SDS data transfer to multiple MCData users with end-to-end encryption.

In step 2A2, the MCData client 103A sends an ad hoc group standalone data transfer request to an MCData server 105 of a primary MCData system. The ad hoc group standalone data transfer request (or first data transfer request message) includes criteria to be applied by the MCData server 105 of the primary MCData system for determining a list of MCData users or includes a list of MCData users as selected by the user at the MCData client 103A. The request may also include an indicator that the data transfer is for emergency, imminent peril, and/or an application ID for which the data transfer is intended.

In step 2A3, if the ad hoc group communication is supported, the MCData server 105 of the primary MCData system checks whether the MCData user at the MCData client 103A is authorized to initiate the ad hoc group standalone data transfer request. If not authorized, the MCData server 105 rejects the ad hoc group standalone data transfer request in step 2A9.

If the request includes the list of MCData users as selected by the user at the MCData client 103A, the MCData server 105 of the primary MCData system validates whether the number of MCData users provided in the request are within the configured limit. If not within the configured limit, the MCData server 105 rejects the ad hoc group standalone data transfer request in the step 2A9.

In step 2A4, if the ad hoc group standalone data transfer request contains the criteria, the MCData server 105 of primary MCData system determines the list of MCData users for the ad hoc group standalone SDS and determines a partner MCData system 102 to be involved in the ad hoc group standalone SDS based on the criteria and according to local policy, if required. An information element to determine an ad hoc group member may include criteria, an indicator identifying pre-defined criteria, or a combination of both. The values of the criteria, the indicator identifying pre-defined criteria, and determining the list of participants using these values by the MCData server 105 may vary according to implementation.

In step 2A5, the MCData server 105 of primary MCData system involves the partner MCData system based on the agreement, based on the criteria for determining the list of MCData users, and according to local policy, if required. Further, the MCData server 105 sends the ad hoc group standalone data get user list request (or a get user list request message) to an MCData server 104 of partner MCData system. The ad hoc group standalone data get user list request carries the criteria received in the ad hoc group standalone data transfer request.

In step 2A6, the MCData server 104 of partner MCData system determines the list of MCData users satisfying the criteria and sends the ad hoc group standalone data get user list response (or a get user list response message) including the list of MCData users satisfying the criteria. The MCData server 104 of the partner MCData system may apply local policies, if any, while determining the participants satisfying the criteria. The determination of list of MCData users may be performed only once.

In step 2A7, the MCData server 105 of the primary MCData system compiles the list of MCData users for the ad hoc group standalone SDS from the primary MCData system and from the partner MCData system, if requested. Also, the steps 2A4-2A7 are applicable, if the ad hoc group standalone data transfer request includes the criteria for determining the ad hoc group members from the primary system and from the partner system.

In step 2A8, the MCData server 105 of the primary MCData system forms the ad hoc group by using MCData user information received in the ad hoc group standalone data transfer request and the list of MCData users to be part of ad hoc group. The MCData server 105 further determines the preconfigured group to be used for the configuration (e.g., security related information) of the ad hoc group. The MCData server 105 assigns an MCData ad hoc group ID for the newly formed ad hoc group and optionally assigns a time to live value. The ad hoc group members can communicate in the ad hoc group until the time to live value has expired. The MCData server 105 ensure the list of MCData users determined in step 2A7 are within the configured limit.

In step 2A9, the MCData server 105 of the primary MCData system sends the ad hoc group standalone data transfer response message (or a first response message) to the MCData client 103A including the MCData ad hoc group ID (when the ad hoc group standalone data transfer request is successful), the MCData group ID of the pre-configured group whose configuration is to be applied for this ad hoc group standalone SDS if end-to-end encryption is required (when the ad hoc group standalone data transfer request is successful), and a result of whether the ad hoc group standalone data transfer request is successful or not.

If the Ad hoc group standalone data transfer request is not authorized or not successful, the MCData client 103A shall not proceed with remaining steps for the data transfer as specified in the clauses 7.17.A.3 and 7.17.A.4 of TS 23.282.

Table 3 below describes an information flow for an ad hoc group standalone data request sent from an MCData server to an MCData client.

TABLE 3

| | Sta- | |
|---|---|---|
| Information element | tus | Description |
| MCData ID | M | The identity of the MCData user sending |
| | | data |
| Functional alias | O | The associated functional alias of the |
| | | MCData user sending data. |
| MCData ad hoc group | M | The MCData group ID associated with |
| ID | | ad hoc group standalone SDS |
| Preconfigured MCData | O | Group identity whose configuration is to |
| group ID (see NOTE | | be applied for this ad hoc group |
| 1) | | standalone SDS. |
| MCData ID | M | The identity of the MCData user towards |
| | | which the data is sent |
| Conversation Identifier | M | Identifies the conversation |
| Transaction Identifier | M | Identifies the MCData transaction |
| Emergency indicator | O | Indicates that the data request is for |
| (see NOTE 2) | | emergency ad hoc group standalone SDS |
| Imminent peril | O | Indicates that the data request is for |
| indicator (see | | imminent peril ad hoc group standalone |
| NOTE 2) | | SDS |
| Disposition Type | O | Indicates the disposition type expected |
| | | from the receiver (i.e., delivered or read or |
| | | both) |
| Payload Destination | M | Indicates whether the payload is for |
| Type | | application consumption or MCData user |
| | | consumption |
| Location | O | Location of the Originating MCData user |
| | | sending the SDS |
| Application identifier | O | Identifies the application for which the |
| (see NOTE 3) | | payload is intended (e.g., text string, port |
| | | address, URI) |
| Application metadata | O | Implementation specific information that |
| container | | is communicated to the recipient |
| Payload | M | SDS content |
| Time to live | O | Indicates how long the ad hoc group is |
| | | persisted and members can respond to the |
| | | data transfer. |

NOTE 1:
If end-to-end encryption is required, then this element is included.
NOTE 2:
If used, only one of these information elements shall be present.
NOTE 3:
The application identifier shall be included only if the payload destination type indicates that the payload is for application consumption.

Table 4 describes an information flow of an ad hoc group standalone data response from an MCData server to an MCData client.

TABLE 4

| Information Element | Status | Description |
|---|---|---|
| MCData ID | M | The identity of the MCData user |
| | | sending data |
| Functional alias | O | The associated functional alias of |
| | | the MCData user sending data. |
| MCData ad hoc | M | The MCData group ID associated |
| group ID | | with the ad hoc group standalone |
| | | SDS |
| Time to live | O | Indicates how long the ad hoc |
| | | group is persisted and members |
| | | can respond to the data transfer. |
| Result | M | Result of |
| | | standalone SDS (success or |
| | | failure) |

Table 5 describes an information flow of an ad hoc group standalone data get user list from an MCData server to another MCData server.

TABLE 5

| Information element | Status | Description |
|---|---|---|
| MCData ad hoc group | M | The MCData group ID associated with |
| ID | | the ad hoc group standalone SDS |
| Criteria for | M | Carries the details of criteria or |
| determining the | | meaningful label identifying the |
| participants | | criteria or the combination of both |
| | | which will be used by the MCData |
| | | server for determining the list of |
| | | MCData users e.g., it can be a location |
| | | based criteria to SDS data transfer in a |
| | | particular area |

Table 6 describes an information flow of an ad hoc group standalone data get user list response from an MCData server to another MCData server.

TABLE 6

| Information element | Status | Description |
|---|---|---|
| MCData ad hoc group | M | The MCData group ID associated with |
| ID | | the ad hoc group standalone SDS |
| MCData ID list | M | List of MCData IDs meeting the |
| | | criteria specified in the Ad hoc group |
| | | standalone data get user list |

FIGS. 2B to 2E illustrate data transfer procedures that invoke a determination of an ad hoc group and a preconfigured group for end-to-end encryption, if a user or a client wants end-to-end encryption for data transfer. If the user or client does not want end-to end encryption for data transfer, the ad hoc group will be formed as a part of data transfer procedure without invoking the determination procedure.

Table 7 describes an information flow for an Ad hoc group standalone data request sent from an MCData client 103A to an MCData server.

TABLE 7

| | Sta- | |
|---|---|---|
| Information element | tus | Description |
| MCData ID | M | The identity of the MCData user |
| | | sending data |
| Functional alias | O | The associated functional alias of the |
| | | MCData user sending data. |
| MCData ad hoc group | O | The MCData group ID to be associated |
| ID (see NOTE 1) | | with the ad hoc group standalone SDS |
| MCData ID list | O | MCData IDs for the ad hoc group |
| (see NOTE 2, NOTE | | standalone SDS |
| 3, NOTE 4) | | |
| Criteria for | O | Carries the details of criteria or |
| determining the | | meaningful label identifying the criteria |
| participants | | or the combination of both which will |
| (see NOTE 2, | | be used by the MCData server for |
| NOTE 4) | | determining the list of MCData users e.g., |
| | | it can be a location based criteria to SDS |
| | | data transfer in a particular area |
| Preconfigured MCData | O | Group identity whose configuration is to |
| group ID (see NOTE | | be applied for ad hoc group standalone |
| 8) | | SDS. |
| Conversation Identifier | M | Identifies the conversation |
| Transaction Identifier | M | Identifies the MCData transaction |
| Emergency indicator | O | Indicates that the data request is for |
| (see NOTE 5) | | emergency ad hoc group standalone SDS |
| Imminent peril | O | Indicates that the data request is for |
| indicator (see | | imminent peril ad hoc group standalone |
| NOTE 5) | | SDS |
| Disposition Type | O | Indicates the disposition type expected |
| | | from the receiver (i.e., delivered or read or |
| | | both) |
| MCData ID list | O | The specified MCData users who should |
| (see NOTE 6) | | send a disposition notification message. |
| Payload Destination | M | Indicates whether the payload is for |
| Type | | application consumption or MCData user |
| | | consumption |
| Location | O | Location of the Originating MCData user |
| | | sending the SDS |
| Application identifier | O | Identifies the application for which the |
| (see NOTE 7) | | payload is intended (e.g., text string, port |
| | | address, URI) |
| Application metadata | O | Implementation specific information that |
| container | | is communicated to the recipient |
| Payload | M | SDS content |

NOTE 1:
If this information element is not included, the MCData server assigns an MCData ad hoc group ID to be used for the ad hoc group standalone SDS. This information element is returned to the MCData user who is sending the data to use in the ad hoc group standalone SDS. If this request follows an Ad hoc group standalone data transfer request, then this element must be present, i.e., if end-to-end encryption is required.
NOTE 2:
This information element is not included if this request follows an Ad hoc group standalone data transfer request, i.e., if end-to-end encryption is required.
NOTE 3:
This element is included only when the ad hoc group standalone SDS initiating client sends the list of MCData users and if end-to-end encryption is not required.
NOTE 4:
Only one of these information elements is present if end-to-end encryption is not required.
NOTE 5:
If used, only one of these information elements shall be present.
NOTE 6:
If Disposition Type IE is not present, this IE shall not be present. If Disposition Type IE is present but this IE is not, which indicates that all receivers shall respond with disposition notification message.
NOTE 7:
The application identifier shall be included only if the payload destination type indicates that the SDS message is for application consumption.
NOTE 8:
If this request follows an Ad hoc group standalone data transfer request, then this element must be present, i.e., if end-to-end encryption is required.

FIG. 2B is a signal flow diagram illustrating an ad hoc group standalone SDS using an MCData user list provided by an initiator involving a single MCData system, according to an embodiment. More specifically, FIG. 2B illustrates a scenario in which an MCData user is initiating an ad hoc group standalone SDS using a signaling control plane, with or without disposition request along with the MCData user list provided by the initiating MCData user, to an ad hoc group.

Referring to FIG. 2B, it assumed that MCData users on each of MCData clients belong to the same MCData system and are already registered for receiving an MCData service.

The authorized MCData user at an MCData client 103A wants to invite MCData users at MCData clients 103B-103N for the ad hoc group standalone SDS. The number of ad hoc group members receiving the SDS data is within the configured limit. The preconfigured group identity and preconfigured group configuration (e.g., security related information) to be used for an ad hoc group have been preconfigured in the MCData client 103A and other MCData users of the ad hoc group have also received the relevant security related information.

The MCData client 103A is aware of the MCData IDs of the ad hoc group members receiving the SDS data. Selection of MCData IDs of the ad hoc group members receiving the SDS data can be manual or from the user profile configuration data or by any other means.

In step 2B1, the user at MCData client 103A wants to initiate an SDS data transfer to multiple MCData users at MCData clients 103B-103N.

In step 2B2, if end-to-end encryption is required, the MCData client 103A will execute the procedures as described in the clause 7.17.A.2 of TS 23.282.

In step 2B3, the MCData client 103A sends an Ad hoc group standalone data request (or a second data transfer request message) to the MCData server 105. If end-to-end encryption is required, the request shall include the ad hoc group ID and a preconfigured MCData group ID as determined in step 2B2. If end-to-end encryption is not required, the request includes a list of MCData users as selected by the user at MCData client 103A. The request shall include a conversation ID for message thread indication, may include additional implementation specific information in the application metadata container, may include a disposition request if indicated by the user at MCData client 103A, and may include associated functional alias of the user at MCData client 103A.

If end-to-end encryption is not required, then a payload without encryption is included, but if required, then a payload with encryption is included, based on the received preconfigured MCData group ID. If the MCData user at the MCData client 103A initiates an emergency ad hoc group standalone SDS or the MCData emergency state is already set for the MCData client 103A (e.g., due to a previously triggered MCData emergency alert), the ad hoc group standalone data request may contain an emergency indicator. Further, if the MCData emergency state is not set already, the MCData client 103A sets its MCData emergency state. The MCData emergency state is retained until explicitly cancelled and once an emergency SDS data transfer has been initiated, the ad hoc group is considered to be in an in-progress emergency state until an SDS data transfer is completed and/or a time to live value of ad hoc group has expired.

If the MCData user at the MCData client 103A initiates an imminent peril ad hoc group standalone SDS, the ad hoc group standalone data request may include an imminent peril indicator; and once an emergency SDS data transfer has been initiated, the ad hoc group is considered to be in an in-progress imminent peril state until the SDS data transfer is completed and/or a time to live value of the ad hoc group has expired.

In step 2B4, if the ad hoc group communication is supported, the MCData server 105 checks whether the MCData user at the MCData client 103A is authorized to send an ad hoc group standalone data request. If not authorized, the MCData server 105 rejects the ad hoc group standalone data request in step 2B10. The MCData server 105 checks whether any policy is to be asserted to limit certain types of message, or content to certain members, for example, to location or user privilege. The MCData server 105 also verifies whether the provided functional alias can be used and has been activated for the user. If the ad hoc group communication is supported and if end-to-end encryption is not required, the MCData server 105 validates whether the number of MCData users provided in the request are within the configured limit before proceeding with the SDS data transfer. If not within the configured limit, the MCData server 105 rejects the ad hoc group standalone data request in step 2B10.

In step 2B5, if end-to-end encryption not required, the procedure in this step executed. Specifically, the MCData server 105 forms the ad hoc group by using MCData user information received in the ad hoc group standalone data request and a list of MCData users to be part of the ad hoc group. The MCData server 105 assigns an MCData ad hoc group ID for the newly formed ad hoc group and optionally assigns a time to live value. The ad hoc group members can communicate in the ad hoc group until the time to live value has expired.

In step 2B6, the MCData server 105 considers the list of MCData users provided in the request or the list of MCData users from the ad hoc group as implicitly affiliated to the ad hoc group.

If an emergency indicator is present in the received ad hoc group standalone data request and if the ad hoc group is not in the in-progress emergency state, the ad hoc group is considered to be in the in-progress emergency state until SDS data transfer is completed and/or a time to live value of the ad hoc group has expired.

If an imminent peril indicator is present in the received ad hoc group standalone data request and if the ad hoc group is not in the in-progress imminent peril state, the ad hoc group is considered to be in the in-progress imminent peril state until SDS data transfer is completed and/or a time to live value of the ad hoc group has expired.

In step 2B7, the MCData server 105 initiates an ad hoc group standalone data request to each of the target MCData users at MCData clients 103B-103N. While sending an ad hoc group standalone data request (or a second data transfer request message), the MCData server 105 may remove the information elements that are not required to be conveyed to the target MCData clients (e.g., MCData ID list). The request should contain the ad hoc group ID, a pre-configured group, if end-to-end encryption is required, and a time to live value for the ad hoc group.

In step 2B8, if the payload is for MCData user consumption (e.g., is not application data, is not command instructions, etc.) then the MCData users of MCData clients 103B-103N may be notified. Otherwise, if the payload is not for MCData user consumption, then the MCData user of MCData clients 103B-103N shall not be notified.

The action taken when the payload contains application data or command instructions may be based on the contents of the payload. For example, payload content received by MCData client 103B, which is addressed to a known local non-MCData application that is not yet running, shall cause the MCData client 103B to start the local non-MCData application (i.e., remote start application) and pass the payload content to the just started application.

In step 2B9, the receiving MCData clients 103B-103N send ad hoc group standalone data responses to the MCData server 105.

In step 2B10, the MCData server 105 sends the ad hoc group standalone data response (or a second data response message) to the MCData client 103A through the signaling path to inform about a result of the SDS data transfer including any error (e.g., the Ad hoc group standalone data request authorization failure). The Ad hoc group standalone data response may contain the ad hoc group ID, the pre-configured group, if end-to-end encryption is required, and a time to live value for the ad hoc group. The primary MCData server 105 removes the ad hoc group information from the dynamic data once the time to live value has expired and thus the ad hoc group ceases to exist.

In step 2B11, if the MCData data disposition for delivery was requested by the user at the MCData client 103A, then the receiving MCData clients 103B-103N initiate an MCData data disposition notification for a delivery report as described in step 6 to step 9 of clause 7.4.2.5.2 of TS 23.282.

FIG. 2C is a signal flow diagram illustrating an ad hoc group standalone SDS using an MCData user list provided by an MCData server involving a single MCData system, according to an embodiment. More specifically, FIG. 2C illustrates a scenario in which an MCData user is initiating an ad hoc group standalone SDS using a signaling control plane, with or without a disposition request, and the MCData user list is provided by the MCData server 105, to an ad hoc group.

Referring to FIG. 2C, it is assumed that the MCData users on MCData clients 103A-103N) belong to the same MCData system and are already registered for receiving an MCData service. The authorized MCData user at the MCData client 103A wants to invite MCData users who satisfy certain criteria for the ad hoc group standalone SDS. The number of ad hoc group members receiving the SDS data is within the configured limit. The preconfigured group identity and preconfigured group configuration (e.g., security related information) to be used for an ad hoc group have been preconfigured in the MCData client and other MCData users of ad hoc group have also received the relevant security related information.

In step 2C1, the user at the MCData client 103A wants to initiate an SDS data transfer to multiple MCData users satisfying specific criteria.

In step 2C2, if the end-to-end encryption is required, the MCData client 103A will execute the procedures as described in the clause 7.17.A.2 of TS 23.282.

In step 2C3, the MCData client 103A sends an ad hoc group standalone data request to the MCData server 105. If end-to-end encryption is required, the request may include the ad hoc group ID and a preconfigured MCData group ID as determined in step 2C2. If end-to-end encryption is not required, the request may include details of the criteria to be applied by the MCData server 105 for determining a list of MCData users. The request may include a conversation ID for message thread indication, may include additional implementation specific information in the application metadata container, may include a disposition request if indicated by the user at MCData client 103A, and may include associated functional alias of the user at the MCData client 103A. If the end-to-end encryption is not required, then payload without encryption is included, but if encryption is required, then payload with encryption is included, based on the received preconfigured MCData group ID. If the MCData user at the MCData client 103A initiates an emergency ad hoc group standalone SDS or the MCData emergency state is already set for the MCData client 103A (e.g., due to a previously triggered MCData emergency alert):
i. the ad hoc group standalone data request may include an emergency indicator;
ii. if the MCData emergency state is not set already, MCData client 103A sets its MCData emergency state. The MCData emergency state is retained until explicitly cancelled; and
iii. once an emergency SDS data transfer has been initiated, the ad hoc group is considered to be in an in-progress emergency state until SDS data transfer is completed and/or a time to live value of the ad hoc group has expired.

Also, If the MCData user at the MCData client 103A initiates an imminent peril ad hoc group standalone SDS:
i. the Ad hoc group standalone data request may include imminent peril indicator; and
ii. once an emergency SDS data transfer has been initiated, the ad hoc group is considered to be in an in-progress imminent peril state until SDS data transfer is completed and/or a time to live value of the ad hoc group has expired.

In step 2C4, if the ad hoc group communication is supported, the MCData server 105 checks whether the MCData user at the MCData client 103A is authorized to send the ad hoc group standalone data request. If not authorized, the MCData server 105 rejects the ad hoc group standalone data request in step 2C11. The MCData server 105 checks whether any policy is to be asserted to limit certain types of message, or content to certain members, e.g., to location or user privilege. The MCData server 105 also verifies whether the provided functional alias can be used and has been activated for the user.

In step 2C5, if the request includes the criteria, the MCData server 105 determines the list of MCData users for the ad hoc group standalone SDS based on the criteria and according to local policy, if required. An information element to determine the ad hoc group members may include the criteria, an indicator identifying pre-defined criteria, or a combination of both. The MCData server 105 ensures the list of MCData users determined are within the configured limit. The values of criteria, indicator identifying pre-defined criteria and determining the list of participants using these values by the MCData server 105 may vary according to implementation.

In step 2C6, the MCData server 105 forms the ad hoc group by using MCData user information received in the ad hoc group standalone data request and determined list of MCData users to be part of ad hoc group. The MCData server 105 assigns an MCData ad hoc group ID for the newly formed ad hoc group and optionally assigns the time to live value. The ad hoc group members can communicate in the ad hoc group until the time to live value has expired.

Step 2C5 to 2C6 are applicable if end-to-end encryption is not required.

In step 2C7, the MCData server 105 considers the list of MCData users determined in step 2C5 or the list of MCData users from the ad hoc group as implicitly affiliated to the ad hoc group.
i. If an emergency indicator is present in the received ad hoc group standalone data request and if the ad hoc group is not in the in-progress emergency state, the ad hoc group is considered to be in the in-progress emergency state until SDS data transfer is completed; and
ii. If an imminent peril indicator is present in the received ad hoc group standalone data request and if the ad hoc group is not in the in-progress imminent peril state, the ad hoc group is considered to be in the in-progress imminent peril state until SDS data transfer is completed;

In step 2C8, the MCData server 105 initiates an ad hoc group standalone data request (or a second data transfer request message) to each of the target MCData users. While sending the ad hoc group standalone data request, the MCData server 105 may remove the information elements that are not required to be conveyed to the target MCData clients (e.g., MCData ID list). The request may include the ad hoc group ID, a pre-configured group, if end-to-end encryption is required, and a time to live value for the ad hoc group.

In step 2C9, if the payload is for MCData user consumption (e.g., is not application data, is not command instructions, etc.) then the MCData users of MCData clients 103B-103N may be notified. Otherwise, if the payload is not for MCData user consumption, then the MCData user of the MCData clients 103B-103N may not be notified.

The action taken when the payload contains application data or command instructions may be based on the contents of the payload. For example, payload content received by the MCData client 103B, which is addressed to a known local non-MCData application that is not yet running, may cause the MCData client 103B to start the local non-MCData application (i.e., remote start application) and to pass the payload content to the just started application.

In step 2C10, the receiving MCData clients send ad hoc group standalone data responses to the MCData server 105.

In step 2C11, the MCData server 105 sends the ad hoc group standalone data response (or a second data response message) to the MCData client 103A through the signaling path to inform about a result of the SDS data transfer including any error (e.g., the ad hoc group standalone data request authorization failure). The response may include the ad hoc group ID, a pre-configured group, if end-to-end encryption is required, and a time to live value for the ad hoc group. The primary MCData server 105 removes the ad hoc group information from the dynamic data once the time to live value has expired and thus the ad hoc group ceases to exist.

In step 2C12, if the MCData data disposition for delivery was requested by the user at the MCData client 103A, then the receiving MCData clients 103B-103N initiate an MCData data disposition notification for delivery report as described in step 6 to step 9 of clause 7.4.2.5.2 of TS 23.282.

FIG. 2D is a signal flow diagram illustrating an ad hoc group standalone SDS using an MCData user list provided by an initiator involving multiple MCData systems, according to an embodiment. More specifically, FIG. 2D illustrates a scenario in which an MCData user is initiating ad hoc group standalone SDS using a signaling control plane, with or without a disposition request, along with the MCData user list provided by the initiating MCData user, to an ad hoc group.

Referring to FIG. 2D, security aspects of sharing the user information between primary and partner MCData systems may be governed as per the service provider agreement between them. In this case, it is assumed that the partner MCData system share their user information to the primary MCData system, MCData users on MCData clients 103A-103N belong to the primary MCData system, and MCData users on MCData clients 203A-203N belong to the partner MCData system and are already registered for receiving MCData service. The authorized MCData user at the MCData client 103A wants to invite MCData users at MCData clients 103B-103N and MCData clients 203A-203N for the ad hoc group standalone SDS. The MCData server 105 of the primary MCData system is where the authorized MCData user/dispatcher creates the ad hoc group. The number of ad hoc group members receiving the SDS data is within the configured limit. The preconfigured group identity and preconfigured group configuration (e.g., security related information) to be used for an ad hoc group have been preconfigured in the MCData client and other MCData users of ad hoc group have also received the relevant security related information. The MCData client 103A is aware of the MCData IDs of the ad hoc group members receiving the SDS data. Selection of MCData IDs of the ad hoc group members receiving the SDS data can be manual or from the user profile configuration data or by any other means. This is left for the implementation.

In step 2D1, the user at the MCData client 103A wants initiates an SDS data transfer to multiple MCData users from primary and partner MCData systems.

In step 2D2, if end-to-end encryption is required, the MCData client 103A will execute procedures as described in the clause 7.17.A.2 of TS 23.282.

In step 2D3, the MCData client 103A sends an ad hoc group standalone data request to the MCData server 105. If end-to-end encryption is required, the request may include the ad hoc group ID and a preconfigured MCData group ID as determined in step 2D2. If end-to-end encryption is not required, the request may include a list of MCData users as selected by the user at MCData client 103A. The ad hoc group standalone data request may include a conversation ID for message thread indication, additional implementation specific information in the application metadata container, a disposition request if indicated by the user at MCData client 1103A, and associated functional alias of the user at MCData client 103A. If end-to-end encryption is not required, then payload without encryption is included, but if end-to-end encryption is required, then the payload with encryption is included, based on the received preconfigured MCData group ID. If the MCData user at the MCData client 103A initiates an emergency ad hoc group standalone SDS or the MCData emergency state is already set for the MCData client 103A (e.g., due to a previously triggered MCData emergency alert):
i) the ad hoc group standalone data request may include an emergency indicator;
ii) if the MCData emergency state is not set already, MCData client 103A sets its MCData emergency state. The MCData emergency state is retained until explicitly cancelled; and
iii) once an emergency SDS data transfer has been initiated, the ad hoc group is considered to be in an in-progress emergency state until the SDS data transfer is completed and/or a time to live value of the ad hoc group has expired.

If the MCData user at the MCData client 103A initiates an imminent peril ad hoc group standalone SDS:
i) the ad hoc group standalone data request may include an imminent peril indicator; and
ii) once an emergency SDS data transfer has been initiated, the ad hoc group is considered to be in an in-progress imminent peril state until the SDS data transfer is completed and/or a time to live value of the ad hoc group has expired.

In step 2D4, if the ad hoc group communication is supported, the MCData server 105 checks whether the MCData user at the MCData client 103A is authorized to send the ad hoc group standalone data request. If not authorized, the MCData server 105 rejects the ad hoc group standalone data request in step 2D10. The MCData server 105 checks whether any policy is to be asserted to limit certain types of message, or content to certain members, e.g., to location or user privilege. The MCData server 105 also verifies whether the provided functional alias can be used and has been activated for the user.

If the ad hoc group communication supported and if end-to-end encryption is not required, the MCData server 105 validates whether the number of MCData users provided in the request are within the configured limit before proceeding with the SDS data transfer. If not within the configured limit, the MCData server 105 rejects the ad hoc group standalone data request in step 2D10.

In step 2D5, if the end-to-end encryption not required, the procedure in this step executed. Specifically, the MCData server 105 forms the ad hoc group by using MCData user information received in the ad hoc group standalone data request and a list of MCData users to be part of the ad hoc group. The MCData server 105 assigns an MCData ad hoc group ID for the newly formed ad hoc group and optionally assigns the time to live value. The ad hoc group members can communicate in the ad hoc group until the time to live value has expired.

In step 2D6, the MCData server 105 considers the list of MCData users provided in the request or the list of MCData users from the ad hoc group as implicitly affiliated to the ad hoc group.
i. If an emergency indicator is present in the received ad hoc group standalone data request and if the ad hoc group is not in the in-progress emergency state, the ad hoc group is considered to be in the in-progress emergency state until SDS data transfer is completed and/or a time to live value of the ad hoc group has expired; and
ii. If an imminent peril indicator is present in the received ad hoc group standalone data request and if the ad hoc group is not in the in-progress imminent peril state, the ad hoc group is considered to be in the in-progress imminent peril state until the SDS data transfer is completed and/or a time to live value of the ad hoc group has expired.

In steps 2D7a and 2D7b, the MCData server 105 of the primary MCData system initiates an ad hoc group standalone data request (or a second data transfer request message) to each of the target MCData users in the primary MCData system and the partner MCData system. While sending the ad hoc group standalone data requests, the MCData server 105 of the primary MCData system may remove information elements that are not required to be conveyed to the target MCData clients (e.g., MCData ID list). The request may include the ad hoc group ID, a pre-configured group, if end-to-end encryption is required, and a time to live value for the ad hoc group.

In steps 2D8a and 2D8b, if the payload is for MCData user consumption (e.g., is not application data, is not command instructions, etc.) then the MCData users of MCData clients 103B-103N and 106A-106N may be notified. Otherwise, if the payload is not for MCData user consumption, then the MCData users of MCData clients 103B-103N and 106A-106N shall not be notified.

The action taken when the payload contains application data or command instructions may be based on the contents of the payload. For example, payload content received by MCData clients 103B-103N and 106A-106N, which is addressed to a known local non-MCData application that is not yet running, shall cause the MCData clients 103B-103N and 106A-106N to start the local non-MCData application (i.e., remote start application) and shall pass the payload content to the just started application.

In steps 2D9a and 2D9b, the receiving MCData clients send ad hoc group standalone data responses to the MCData server 105.

In step S10, the MCData server 105 of the primary MCData system sends the ad hoc group standalone data response (or a second data response message) to the MCData client 103A through the signaling path to inform about a result of SDS data transfer including any error (e.g., the ad hoc group standalone data request authorization failure). The response may include the ad hoc group ID, a pre-configured group, if end-to-end encryption is required, and a time to live value for the ad hoc group. The primary MCData server 105 removes the ad hoc group information from the dynamic data once the time to live value has expired and thus the ad hoc group ceases to exist.

In step 2D11, if the MCData data disposition for delivery was requested by the user at MCData client 103A, then the receiving MCData clients initiate an MCData data disposition notification for delivery report as described in steps 6 to 9 of clause 7.4.2.5.2 of TS 23.282.

FIG. 2E is a signal flow diagram illustrating an ad hoc group standalone SDS using an MCData user list provided by an MCData server involving multiple MCData systems, according to an embodiment. More specifically, FIG. 2E illustrates a scenario in which an MCData user is initiating ad hoc group standalone SDS using a signaling control plane, with or without a disposition request, and the MCData user list is provided by the MCData server of the primary MCData system, to an ad hoc group.

Referring to FIG. 2E, it is assumed that security aspects of sharing the user information between primary and partner MCData systems shall be governed as per the service provider agreement between them. In this case, it is assumed that the partner MCData system share their user information to the primary MCData system. The MCData users on MCData clients 103B-103N belong to the primary MCData system and MCData users on MCData clients 106A-106N belong to the partner MCData system and are already registered for receiving MCData service. The authorized MCData user at MCData client 103A wants to invite MCData users who are satisfying certain criteria for the ad hoc group standalone SDS. The MCData server 105 of the primary MCData system is where the authorized MCData user/dispatcher creates the ad hoc group. The number of ad hoc group members receiving the SDS data is within the configured limit. The preconfigured group identity and preconfigured group configuration (e.g., security related information) to be used for an ad hoc group have been preconfigured in the MCData client and other MCData users of ad hoc group have also received the relevant security related information.

In step 2E1, the user at the MCData client 103A wants to initiate an SDS data transfer to multiple MCData users from primary and partner MCData systems satisfying specific criteria.

Steps 2E2-2E4, are the same as steps 2 to 4 of clause 7.17.A.3.3 of TS 23.282.

In step 2E5, if the request contains the criteria, the MCData server 105 of the primary MCData system determines a list of MCData users for the ad hoc group standalone SDS from the primary MCData system and determines the partner MCData system to be involved in the ad hoc group standalone SDS based on the criteria and according to local policy, if required. An information element to determine the ad hoc group member may include the criteria, an indicator identifying pre-defined criteria, or a combination of both. The MCData server 105 ensures the list of MCData users determined are within the configured limit.

The content of the criteria information element, the details of the pre-defined criteria, and how the MCData server 105 determines the list of participants may vary according to implementation.

In step 2E6, the MCData server 105 of the primary MCData system involves the partner MCData system based on the agreement, based on the criteria for determining the list of MCData users, and according to local policy if required. The MCData server 105 sends the ad hoc group standalone data get user list request to the MCData server of the partner MCData system. This request carries the criteria specified in the step 2E3.

In step 2E7, the MCData server 104 of the partner MCData system determines the list of MCData users satisfying the criteria and sends the response containing the list of MCData users satisfying the criteria. The MCData server 104 of the partner MCData system may apply local policies if any while determining the participants satisfying the criteria. The determination of list of MCData users is performed only once.

In step 2E8, the MCData server 105 of primary MCData system compiles the list of MCData users for the ad hoc group standalone SDS from primary MCData system and from the partner MCData system.

In step 2E9, the MCData server 105 forms the ad hoc group by using MCData user information received in the ad hoc group standalone data request and compiled list of MCData users to be part of ad hoc group. The MCData server 105 assigns an MCData ad hoc group ID for the newly formed ad hoc group and optionally assigns the time to live value. The ad hoc group members can communicate in the ad hoc group until the time to live value has expired.

Steps 2E5 to 2E9 are applicable if end-to-end encryption is not required.

In step 2E10, the MCData server 105 of primary MCData system considers the compiled list of MCData users in step 2E8 or the list of MCData users from the ad hoc group as implicitly affiliated to the ad hoc group.
i. If an emergency indicator is present in the received ad hoc group standalone data request and if the ad hoc group is not in the in-progress emergency state, the ad hoc group is considered to be in the in-progress emergency state until the SDS data transfer is completed; and
ii. If an imminent peril indicator is present in the received ad hoc group standalone data request and if the ad hoc group is not in the in-progress imminent peril state, the ad hoc group is considered to be in the in-progress imminent peril state until SDS data transfer is completed.

Steps 2E11-2E15 are the same as steps 7 to 11 of clause 7.17.A.4.2 of TS 23.282.

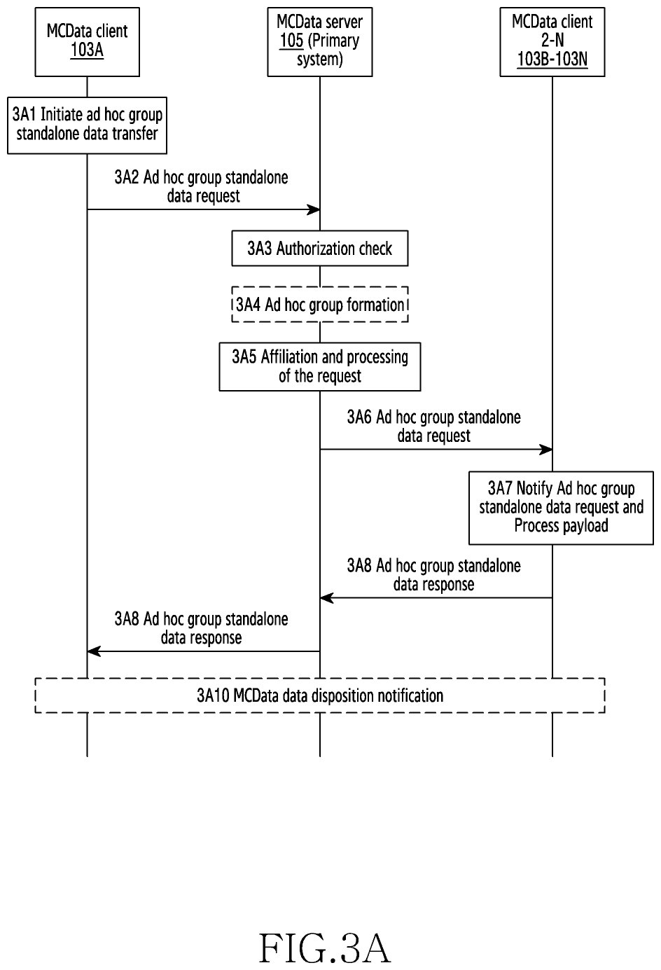

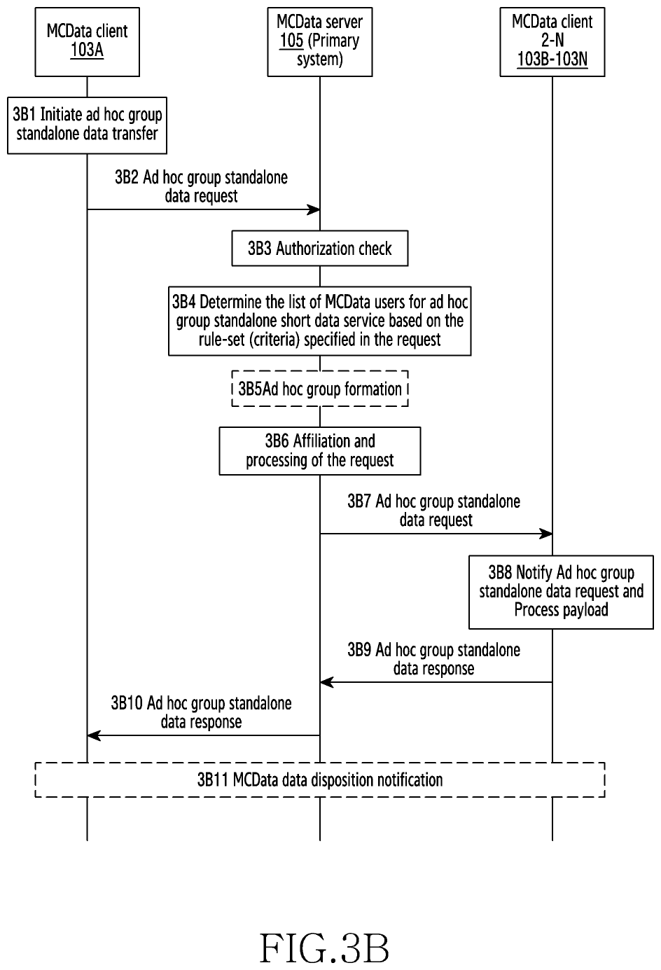

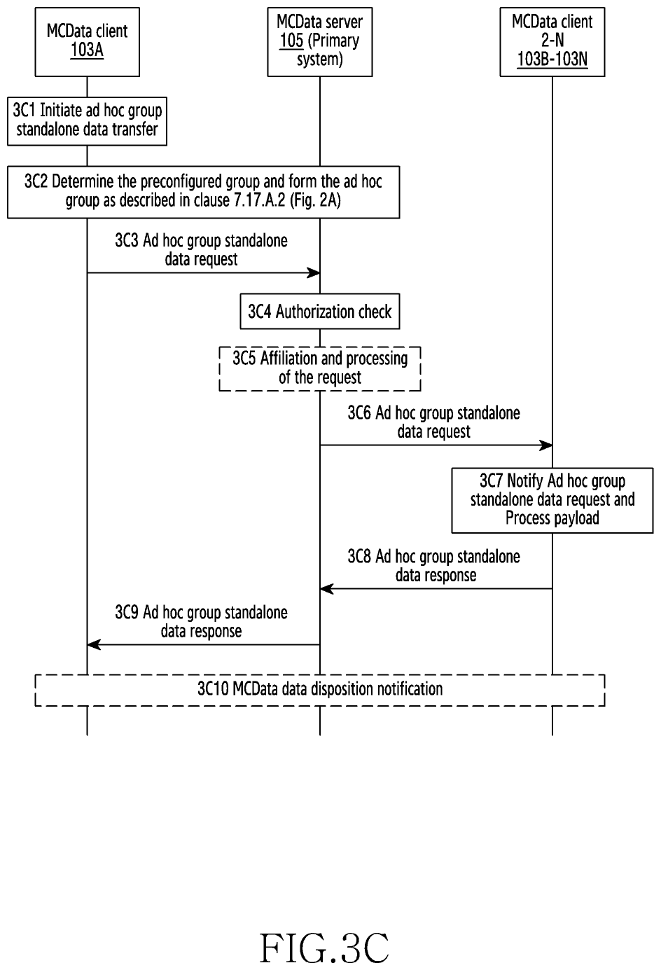

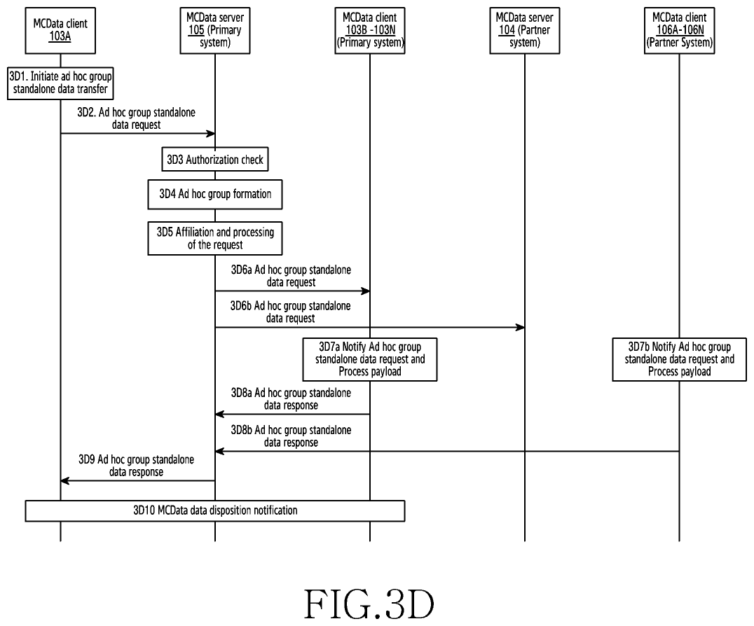

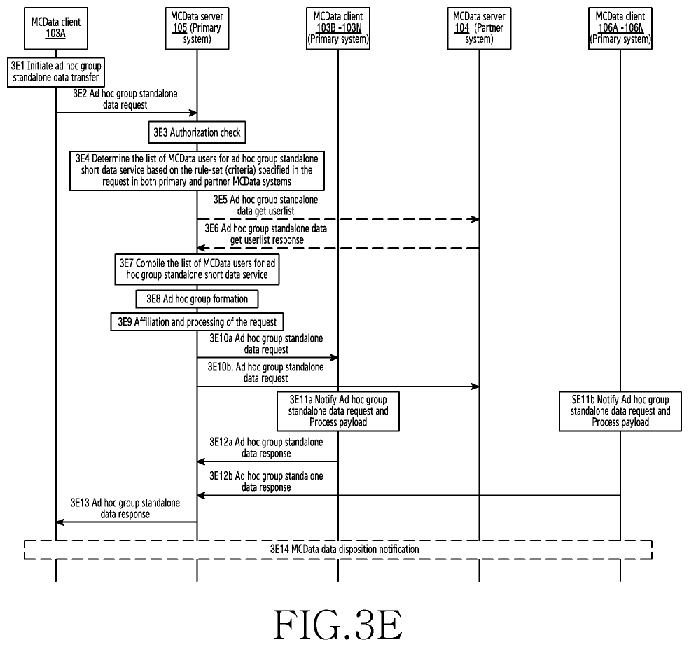

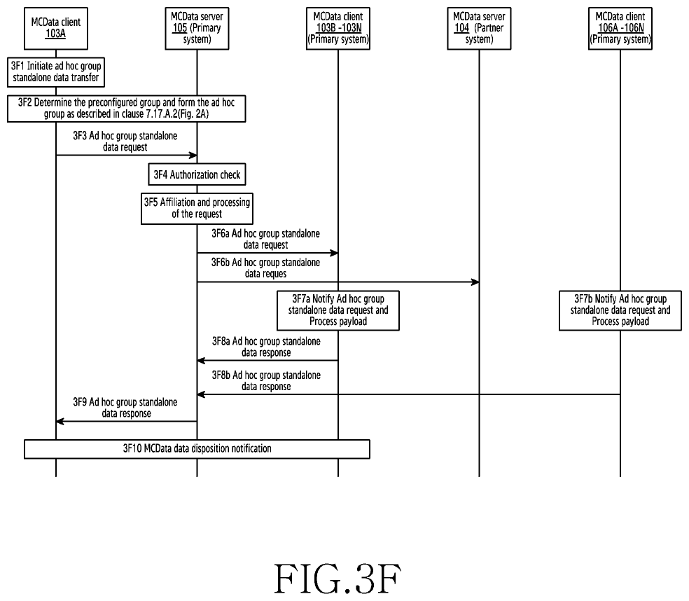

In FIGS. 3A to 3F, if end-to-end encryption for data transfer is required, then a client will determine the ad hoc group and a preconfigured group for end-to-end encryption and then invoke the data transfer request. If a user or client do not want end-to-end encryption for data transfer, the client will invoke the data transfer request and the ad hoc group will be formed as a part of data transfer procedure without invoking the determination procedure.

Table 8 describes an information flow for an ad hoc group standalone data request sent from an MCData client to an MCData server.

TABLE 8

| | Sta- | |
|---|---|---|
| Information element | tus | Description |
| MCData ID | M | The identity of the MCData user |
| | | sending data |
| Functional alias | O | The associated functional alias of the |
| | | MCData user sending data. |
| MCData ad hoc group | O | The MCData group ID to be associated |
| ID (see NOTE 1) | | with the ad hoc group standalone SDS |
| MCData ID list | O | MCData IDs for the ad hoc group |
| (see NOTE 2, NOTE | | standalone SDS |
| 3, NOTE 4) | | |
| Criteria for | O | Carries the details of criteria or |
| determining the | | meaningful label identifying the criteria |
| participants | | or the combination of both which will |
| (see NOTE 2, | | be used by the MCData server for |
| NOTE 4) | | determining the list of MCData users e.g., |
| | | it can be a location based criteria to SDS |
| | | data transfer in a particular area |
| Preconfigured MCData | O | Group identity whose configuration is to |
| group ID (see NOTE | | be applied for ad hoc group standalone |
| 8) | | SDS. |
| Conversation Identifier | M | Identifies the conversation |
| Transaction Identifier | M | Identifies the MCData transaction |
| Emergency indicator | O | Indicates that the data request is for |
| (see NOTE 5) | | emergency ad hoc group standalone SDS |
| Imminent peril | O | Indicates that the data request is for |
| indicator (see | | imminent peril ad hoc group standalone |
| NOTE 5) | | SDS |
| Disposition Type | O | Indicates the disposition type expected |
| | | from the receiver (i.e., delivered or read or |
| | | both) |
| MCData ID list | O | The specified MCData users who should |
| (see NOTE 6) | | send a disposition notification message. |
| Payload Destination | M | Indicates whether the payload is for |
| Type | | application consumption or MCData user |
| | | consumption |
| Location | O | Location of the Originating MCData user |
| | | sending the SDS |
| Application identifier | O | Identifies the application for which the |
| (see NOTE 7) | | payload is intended (e.g., text string, port |
| | | address, URI) |
| Application metadata | O | Implementation specific information that |
| container | | is communicated to the recipient |
| Payload | M | SDS content |

NOTE 1:
If this information element is not included, the MCData server assigns an MCData ad hoc group ID to be used for the ad hoc group standalone SDS. This information element is returned to the MCData user who is sending the data to use in the ad hoc group standalone SDS. If this request follows an Ad hoc group standalone data transfer request, then this element must be present i.e., if end-to-end encryption is required.
NOTE 2:
This information element is not included if this request follows an Ad hoc group standalone data transfer request i.e., if end-to-end encryption is required.
NOTE 3:
This element is included only when the ad hoc group standalone SDS initiating client sends the list of MCData users and if end-to-end encryption is not required.
NOTE 4:
Only one of these information elements is present if end-to-end encryption is not required.
NOTE 5:
If used, only one of these information elements shall be present.
NOTE 6:
If Disposition Type IE is not present, this IE shall not be present. If Disposition Type IE is present but this IE is not, which indicates that all receivers shall respond with disposition notification message.
NOTE 7:
The application identifier shall be included only if the payload destination type indicates that the SDS message is for application consumption.
NOTE 8:
If this request follows an Ad hoc group standalone data transfer request, then this element must be present i.e., if end-to-end encryption is required.

Also, FIGS. 3A to 3F are directed to determining an MCData ad hoc group ID and a preconfigured group identity of a preconfigured group for which the configurations are to be used (e.g., security related information) and ad hoc group standalone data transfer procedure with/without end-to-end encryption. Procedure in which an MCData user list is provided by an initiator without end-to-end encryption (Clause 7.17.A.3.2).

FIG. 3A is a signal flow diagram illustrating an ad hoc group standalone SDS using an MCData user list provided by an initiator involving a single MCData system, according to an embodiment. More specifically, FIG. 3A illustrates a scenario in which an MCData user is initiating an ad hoc group standalone SDS using a signaling control plane, with or without a disposition request, along with the MCData user list provided by the initiating MCData user, to an ad hoc group.

Referring to FIG. 3A, it is assumed that MCData users on MCData clients belong to the same MCData system and are already registered for receiving an MCData service. The authorized MCData user at MCData client 103A wants to invite MCData users at MCData clients 103B-103N for the ad hoc group standalone SDS. The number of ad hoc group members receiving the SDS data is within the configured limit. The preconfigured group identity and preconfigured group configuration (e.g., security related information) to be used for an ad hoc group have been preconfigured in the MCData client and other MCData users of ad hoc group have also received the relevant security related information. The MCData client 103A is aware of the MCData IDs of the ad hoc group members receiving the SDS data. The selection of MCData IDs of the ad hoc group members receiving the SDS data can be manual or from the user profile configuration data or by any other means.

In step 3A1, the user at the MCData client 103A wants to initiate an SDS data transfer to multiple MCData users.

In step 3A2, the MCData client 103A sends an ad hoc group standalone data request to the MCData server 105. The request includes a list of MCData users as selected by the user at the MCData client 103A. The request may include a conversation ID for message thread indication, additional implementation specific information in the application metadata container, a disposition request if indicated by the user at MCData client 103A, and associated functional alias of the user at MCData client 103A. The payload is included without encryption. If the MCData user at MCData client 103A initiates an emergency ad hoc group standalone SDS or the MCData emergency state is already set for the MCData client 103A (e.g., due to a previously triggered MCData emergency alert):
i. the ad hoc group standalone data request may include an emergency indicator;
ii. if the MCData emergency state is not set already, MCData client 103A sets its MCData emergency state. The MCData emergency state is retained until explicitly cancelled; and
iii. once an emergency SDS data transfer has been initiated, the ad hoc group is considered to be in an in-progress emergency state until SDS data transfer is completed and/or a time to live value of the ad hoc group expires.

If the MCData user at the MCData client 103A initiates an imminent peril ad hoc group standalone SDS:
i. the ad hoc group standalone data request may include an imminent peril indicator; and
ii. once an emergency SDS data transfer has been initiated, the ad hoc group is considered to be in an in-progress imminent peril state until SDS data transfer is completed and/or a time to live value of the ad hoc group expires.

In step 3A3, if the ad hoc group communication is supported, the MCData server 105 checks whether the MCData user at the MCData client 103A is authorized to send the ad hoc group standalone data request. If not authorized, the MCData server 105 rejects the ad hoc group standalone data request in step 3A9.

The MCData server 105 checks whether any policy is to be asserted to limit certain types of message or content to certain members, e.g., to location or user privilege. The MCData server 105 also verifies whether the provided functional alias can be used and has been activated for the user. The MCData server 105 validates whether the number of MCData users provided in the request are within the configured limit before proceeding with the SDS data transfer. If not within the configured limit, the MCData server 105 rejects the ad hoc group standalone data request in step 3A9.

In step 3A4, the MCData server 105 forms the ad hoc group by using MCData user information received in ad hoc group standalone data request and a list of MCData users to be part of the ad hoc group. The MCData server 105 assigns an MCData ad hoc group ID for the newly formed ad hoc group and optionally assigns the time to live value. The ad hoc group members can communicate in the ad hoc group until the time to live value has expired.

In step 3A5, the MCData server 105 considers the list of MCData users provided in the request as implicitly affiliated to the ad hoc group.
i) If an emergency indicator is present in the received ad hoc group standalone data request and if the ad hoc group is not in the in-progress emergency state, the ad hoc group is considered to be in the in-progress emergency state until the SDS data transfer is completed and/or the time to live value of the ad hoc group expires; and
ii) If an imminent peril indicator is present in the received ad hoc group standalone data request and if the ad hoc group is not in the in-progress imminent peril state, the ad hoc group is considered to be in the in-progress imminent peril state until the SDS data transfer is completed and/or the time to live value of the ad hoc group expires.

In step 3A6, the MCData server 105 initiates an ad hoc group standalone data request towards each of the target MCData users. While sending an ad hoc group standalone data request, the MCData server 105 may remove information elements that are not required to be conveyed to the target MCData clients (e.g., MCData ID list). The request may include the ad hoc group ID, and a time to live value for the ad hoc group.

In step 3A7, if the payload is for MCData user consumption (e.g., is not application data, is not command instructions, etc.) then the MCData users of the MCData clients 103B-103N may be notified. Otherwise, if the payload is not for MCData user consumption, then the MCData users of MCData clients 103B-103N shall not be notified.

The action taken when the payload contains application data or command instructions may be based on the contents of the payload. For example, payload content received by MCData client 103B, which is addressed to a known local non-MCData application that is not yet running, shall cause the MCData client 103B to start the local non-MCData application (i.e., remote start application) and pass the payload content to the just started application.

In step 3A8, the receiving MCData clients 103B-103N send ad hoc group standalone data responses to the MCData server 105.

In step 3A9, the MCData server 105 sends the ad hoc group standalone data response (or a second data response message) to the MCData client 103A through the signaling path to inform about a result of the SDS data transfer, including any error (e.g., the Ad hoc group standalone data request authorization failure). The response may include the ad hoc group ID, and a time to live value for the ad hoc group.

The primary MCData server 105 removes the ad hoc group information from the dynamic data once the time to live value has expired and thus the ad hoc group ceases to exist.

In step 3A10, if the MCData data disposition for delivery was requested by the user at MCData client 103A, then the receiving MCData clients initiate a MCData data disposition notification for delivery report as described in steps 6 to 9 of clause 7.4.2.5.2 of TS 23.282.

FIG. 3B is a signal flow diagram illustrating an ad hoc group standalone SDS using an MCData user list provided by an MCData server involving a single MCData system, according to an embodiment. More specifically, FIG. 3B illustrates a scenario in which an MCData user is initiating ad hoc group standalone SDS using a signaling control plane, with or without a disposition request, and the MCData user list is provided by the MCData server 105, to an ad hoc group.

Referring to FIG. 3B, it is assumed that the MCData users on MCData clients 103A-103N belong to the same MCData system and are already registered for receiving the MCData service. The authorized MCData user at MCData client 103A wants to invite MCData users who are satisfying certain criteria for the ad hoc group standalone SDS. The number of ad hoc group members receiving the SDS data is within the configured limit. The preconfigured group identity and preconfigured group configuration (e.g., security related information) to be used for an ad hoc group have been preconfigured in the MCData clients and other MCData users of ad hoc group have also received the relevant security related information.

In step 3B1, the user at the MCData client 103A wants to initiate an SDS data transfer to multiple MCData users satisfying specific criteria.

In step 3B2, the MCData client 103A sends an ad hoc group standalone data request to the MCData server 105. The request includes the details of the criteria to be applied by the MCData server 105 for determining the list of MCData users. The request may include a conversation ID for message thread indication, additional implementation specific information in the application metadata container, a disposition request if indicated by the user at MCData client 103A, and an associated functional alias of the user at the MCData client 103A. The payload is included without encryption.

If the MCData user at the MCData client 103A initiates an emergency ad hoc group standalone SDS or the MCData emergency state is already set for the MCData client 103A (e.g., due to a previously triggered MCData emergency alert):
i) the ad hoc group standalone data request may include an emergency indicator;
ii) if the MCData emergency state is not set already, the MCData client 103A sets its MCData emergency state. The MCData emergency state is retained until explicitly cancelled; and
iii) once an emergency SDS data transfer has been initiated, the ad hoc group is considered to be in an in-progress emergency state until the SDS data transfer is completed and/or the time to live value of the ad hoc group expires.

If the MCData user at MCData client 103A initiates an imminent peril ad hoc group standalone SDS:
i) the ad hoc group standalone data request may include an imminent peril indicator; and
ii) once an emergency SDS data transfer has been initiated, the ad hoc group is considered to be in an in-progress imminent peril state until SDS data transfer is completed and/or the time to live value of the ad hoc group expires.

In step 3B3, if the ad hoc group communication is supported, the MCData server 105 checks whether the MCData user at the MCData client 103A is authorized to send an ad hoc group standalone data request. If not authorized, the MCData server 105 rejects the ad hoc group standalone data request in step 3B10.

The MCData server 105 checks whether any policy is to be asserted to limit certain types of message or content to certain members, e.g., to location or user privilege. The MCData server 105 also verifies whether the provided functional alias can be used and has been activated for the user.

In step 3B4, if the request contains the criteria, the MCData server 105 determines the list of MCData users for the ad hoc group standalone SDS based on the criteria and according to local policy, if required. An information element to determine the ad hoc group member may include the criteria, an indicator identifying pre-defined criteria, or a combination of both. The MCData server 105 ensures the list of MCData users determined are within the configured limit. The values of criteria, indicator identifying pre-defined criteria and determining the list of participants using these values by MCData server 105 may vary according to implementation.

In step 3B5, the MCData server 105 forms the ad hoc group by using MCData user information received in the ad hoc group standalone data request and determines a list of MCData users to be part of the ad hoc group. The MCData server 105 assigns an MCData ad hoc group ID for the newly formed ad hoc group and optionally assigns the time to live value. The ad hoc group members can communicate in the ad hoc group until the time to live value has expired.

In step 3B6, the MCData server 105 considers the list of MCData users determined in step 3B4 as implicitly affiliated to the ad hoc group.
i. If an emergency indicator is present in the received ad hoc group standalone data request and if the ad hoc group is not in the in-progress emergency state, the ad hoc group is considered to be in the in-progress emergency state until the SDS data transfer is completed and/or the time to live value of the ad hoc group expires; and
ii. If an imminent peril indicator is present in the received ad hoc group standalone data request and if the ad hoc group is not in the in-progress imminent peril state, the ad hoc group is considered to be in the in-progress imminent peril state until the SDS data transfer is completed and/or the time to live value of the ad hoc group expires.

In step 3B7, the MCData server 105 initiates an ad hoc group standalone data request towards each of the target MCData users.

While sending the ad hoc group standalone data request, the MCData server 105 may remove information elements that are not required to be conveyed to the target MCData clients (e.g., MCData ID list). The request may include an ad hoc group ID, a pre-configured group, if end-to-end encryption is required, and a time to live value for the ad hoc group.

Steps 3B8 to 3B11 are the same as steps 7 to 10 of clause 7.17.A.3.2 of TS 23.282.

FIG. 3C is a signal flow diagram illustrating an ad hoc group standalone SDS using end-to-end encryption involving a single MCData system, according to an embodiment. More specifically, FIG. 3C illustrates a scenario in which an MCData user is initiating ad hoc group standalone SDS using a signaling control plane, with or without a disposition request.

Referring to FIG. 3C, it is assumed that the MCData users on MCData clients belong to the same MCData system and are already registered for receiving MCData service. The authorized MCData user at MCData client 103A wants to invite MCData users of the ad hoc group for the ad hoc group standalone SDS. The number of ad hoc group members receiving the SDS data is within the configured limit. The preconfigured group identity and preconfigured group configuration (e.g., security related information) to be used for an ad hoc group have been preconfigured in the MCData client and other MCData users of ad hoc group have also received the relevant security related information.

In step 3C1, the user at the MCData client 103A initiates an SDS data transfer to multiple MCData users from a primary MCData system.

In step 3C2, the MCData client 103A) determines the preconfigured group, if end-to-end encryption is required, and an ad hoc group by executing the procedures described in the clause 7.17.A.2 of TS 23.282.

In step 3C3, the MCData client 103A sends an ad hoc group standalone data request to the MCData server 105. The request may include the MCData ad hoc group ID as determined in step 3C2, a conversation ID for message thread indication, additional implementation specific information in the application metadata container, a disposition request if indicated by the user at MCData client 103A, and an associated functional alias of the user at MCData client 103A. If end-to-end encryption is required, the request may include a preconfigured MCData group ID as determined in step 3C2.

If the end-to-end encryption is not required, then payload without encryption is included, but if end-to-end encryption is required, then the payload with encryption may be included, based on the preconfigured MCData group ID as determined in step 3C2.

If the MCData user at MCData client 103A initiates an emergency ad hoc group standalone SDS or the MCData emergency state is already set for the MCData client 103A (e.g., due to a previously triggered MCData emergency alert):
i) the ad hoc group standalone data request may include an emergency indicator;
ii) if the MCData emergency state is not set already, the MCData client 103A sets its MCData emergency state. The MCData emergency state is retained until explicitly cancelled; and
iii) once an emergency SDS data transfer has been initiated, the ad hoc group is considered to be in an in-progress emergency state until the SDS data transfer is completed and/or the time to live value of the ad hoc group expires.

If the MCData user at the MCData client 103A initiates an imminent peril ad hoc group standalone SDS:
i) the ad hoc group standalone data request may include an imminent peril indicator; and
ii) once an emergency SDS data transfer has been initiated, the ad hoc group is considered to be in an in-progress imminent peril state until the SDS data transfer is completed and/or the time to live value of the ad hoc group expires.

In step 3C4, if the ad hoc group communication is supported, the MCData server 105 checks whether the MCData user at MCData client 103A is authorized to send the ad hoc group standalone data request. If not authorized, the MCData server 105 rejects the ad hoc group standalone data request in step 3C9. The MCData server 105 checks whether any policy is to be asserted to limit certain types of message or content to certain members, e.g., to location or user privilege. The MCData server 105 also verifies whether the provided functional alias can be used and has been activated for the user.

In step 3C5, the MCData server 105 considers the ad hoc group members as implicitly affiliated to the ad hoc group.
i. If an emergency indicator is present in the received ad hoc group standalone data request and if the ad hoc group is not in the in-progress emergency state, the ad hoc group is considered to be in the in-progress emergency state until the SDS data transfer is completed and the time to live value of the ad hoc group expires; and
ii. If an imminent peril indicator is present in the received ad hoc group standalone data request and if the ad hoc group is not in the in-progress imminent peril state, the ad hoc group is considered to be in the in-progress imminent peril state until the SDS data transfer is completed and the time to live value of the ad hoc group expires.

In step 3C6, the MCData server 105 initiates an ad hoc group standalone data request to each of the target MCData users. While sending the ad hoc group standalone data request, the MCData server 105 may remove information elements that are not required to be conveyed to the target MCData clients (e.g., MCData ID list). The request may include the ad hoc group ID, a pre-configured group, if end-to-end encryption is required, and a time to live value for the ad hoc group.

In step 3C7, if the payload is for MCData user consumption (e.g., is not application data, is not command instructions, etc.) then the MCData users of MCData clients 103B-103N may be notified. Otherwise, if the payload is not for MCData user consumption, then the MCData users of MCData clients 103B-103N shall not be notified.

The action taken when the payload contains application data or command instructions may be based on the contents of the payload. For example, payload content received by the MCData client103B, which is addressed to a known local non-MCData application that is not yet running, shall cause the MCData client 103B to start the local non-MCData application (i.e., remote start application) and pass the payload content to the just started application.

In step 3C8, the receiving MCData clients 103B-103N send ad hoc group standalone data responses to the MCData server 105.

In step 3C9, the MCData server 105 sends the ad hoc group standalone data response to the MCData client 103A through the signaling path to inform about a result of the SDS data transfer, including any error (e.g., the Ad hoc group standalone data request authorization failure). The response may include the ad hoc group ID, a pre-configured group, if end-to-end encryption is required, and a time to live value for the ad hoc group.

The primary MCData server 105 removes the ad hoc group information from the dynamic data once the time to live value has expired and thus the ad hoc group ceases to exist.

In step 3C10, if the MCData data disposition for delivery was requested by the user at MCData client 103A, then the receiving MCData clients initiate an MCData data disposition notification for delivery report as described in steps 6 to 9 of clause 7.4.2.5.2 of TS 23.282.

FIG. 3D is a signal flow diagram illustrating an ad hoc group standalone SDS using an MCData user list provided by an initiator involving multiple MCData systems, according to an embodiment. FIG. 3D describes the case where an MCData user is initiating ad hoc group standalone SDS using signaling control plane with or without disposition request along with the MCData user list provided by the initiating MCData user, to an ad hoc group.

Referring to FIG. 3D, it is assumed that the security aspects of sharing the user information between primary and partner MCData systems is governed as per the service provider agreement between them. In this case, it is also assumed that the partner MCData systems share their user information to the primary MCData system. MCData users on MCData clients 103B-103N belong to the primary MCData system and MCData users on MCData clients 106A-106N belong to the partner MCData system 102 and are already registered for receiving MCData service. The authorized MCData user at the MCData client 103A wants to invite MCData users at MCData clients 103B-103N and MCData clients 106A-106N for the ad hoc group standalone SDS. The MCData server 105 of the primary MCData system is where the authorized MCData user/dispatcher creates the ad hoc group.

The number of ad hoc group members receiving the SDS data is within the configured limit. The preconfigured group identity and preconfigured group configuration (e.g., security related information) to be used for an ad hoc group have been preconfigured in the MCData client and other MCData users of ad hoc group have also received the relevant security related information. The MCData client 103A is aware of the MCData IDs of the ad hoc group members receiving the SDS data. The selection of MCData IDs of the ad hoc group members receiving the SDS data can be manual or from the user profile configuration data or by any other means.

In step 3D1, the user at the MCData client 103A initiates an SDS data transfer to multiple MCData users from primary and partner MCData systems.

Steps 3D2-3D5 are the same as steps 2 to 5 of clause 7.17.A.3.2 of TS 23.282.

In steps 3D6a and 3D6b, the MCData server 105 of the primary MCData system initiates an ad hoc group standalone data request (or a second data transfer request message) to each of the target MCData users in the primary MCData system and the partner MCData system.

While sending the ad hoc group standalone data requests, the MCData server 105 of the primary MCData system 101 may remove information elements that are not required to be conveyed to the target MCData clients (e.g., MCData ID list). The request may include the ad hoc group ID, and a time to live value for the ad hoc group.

In steps 3D7a and 3D7b, if the payload is for MCData user consumption (e.g., is not application data, is not command instructions, etc.) then the MCData users of the MCData clients 103B-103N and 106A-106N may be notified. Otherwise, if the payload is not for MCData user consumption, then the MCData users of the MCData clients 103B-103N and 106A-106N shall not be notified.

The action taken when the payload contains application data or command instructions may be based on the contents of the payload. For example, payload content received by the MCData clients 103B-103N and 106A-106N, which is addressed to a known local non-MCData application that is not yet running, shall cause the MCData clients 103B-103N and 106A-106N to start the local non-MCData application (i.e., remote start application) and pass the payload content to the just started application.

In steps 3D8a and 3D8b, the receiving MCData clients 103B-103N and 106A-106N send ad hoc group standalone data responses to the MCData server 105.

In step 3D9, the MCData server 105 of the primary MCData system sends the ad hoc group standalone data response to the MCData client 103A through the signaling path to inform about a result of SDS data transfer, including any error (e.g., the Ad hoc group standalone data request authorization failure). The response may include the ad hoc group ID, and a time to live value for the ad hoc group.

The primary MCData server 105 removes the ad hoc group information from the dynamic data once the time to live value has expired and thus the ad hoc group ceases to exist.

In step 3D10, if the MCData data disposition for delivery was requested by the user at the MCData client 103A, then the receiving MCData clients initiate a MCData data disposition notification for delivery report as described in steps 6 to 9 of clause 7.4.2.5.2 of TS 23.282.

FIG. 3E is a signal flow diagram illustrating an ad hoc group standalone SDS using an MCData user list provided by an MCData server involving multiple MCData systems, according to an embodiment. More specifically, FIG. 3E illustrates a scenario in which an MCData user is initiating ad hoc group standalone SDS using a signaling control plane, with or without a disposition request, and the MCData user list is provided by the MCData server of the primary MCData system, to an ad hoc group.

Referring to FIG. 3E, it is assumed that the security aspects of sharing the user information between primary and partner MCData systems are governed as per the service provider agreement between them. In this case, it is also assumed that the partner MCData systems share their users information with the primary MCData system. MCData users on MCData clients 103B-103N belong to the primary MCData system and MCData users on MCData clients 106A-106N belong to the partner MCData system 102 and are already registered for receiving the MCData service. The authorized MCData user at MCData client 103A wants to invite MCData users who satisfy certain criteria for the ad hoc group standalone SDS. The MCData server 105 of the primary MCData system is where the authorized MCData user/dispatcher creates the ad hoc group. The number of ad hoc group members receiving the SDS data is within the configured limit. The preconfigured group identity and preconfigured group configuration (e.g., security related information) to be used for an ad hoc group have been preconfigured in the MCData client and other MCData users of ad hoc group have also received the relevant security related information.

In step 3E1, the user at the MCData client 103A initiates an SDS data transfer to multiple MCData users from primary and partner MCData systems satisfying specific criteria.

Steps 3E2 and 3ES3 are the same as steps 2 to 3 of clause 7.17.A.3.3 of TS 23.282.

In step S3E4, if the request contains the criteria, the MCData server 105 of the primary MCData system determines the list of MCData users for the ad hoc group standalone SDS from the primary MCData system and determines the partner MCData system to be involved in the ad hoc group standalone SDS based on the criteria and according to local policy, if required. An information element to determine the ad hoc group member may include the criteria, an indicator identifying pre-defined criteria, or a combination of both.

The MCData server (105) ensures the list of MCData users determined are within the configured limit. The content of the criteria information element, the details of the pre-defined criteria, and the way how their MCData server determines the list of participants may vary according to implementation.

In step 3E5, the MCData server 105 of primary MCData system involves the partner MCData system based on the agreement, based on the criteria for determining the list of MCData users, and according to local policy, if required. The MCData server 105 sends the ad hoc group standalone data get user list request to the MCData server of the partner MCData system. This request carries the criteria specified in step 3E3.

In step 3E6, the MCData server 104 of partner MCData system determines the list of MCData users satisfying the criteria and sends the response containing the list of MCData users satisfying the criteria. The MCData server 104 of partner MCData system may apply local policies, if any, while determining the participants satisfying the criteria. The determination of list of MCData users may be performed only once.

In step 3E7, the MCData server 105 of the primary MCData system compiles the list of MCData users for the ad hoc group standalone SDS from primary MCData system and from the partner MCData system.

In step 3E8, the MCData server 105 forms the ad hoc group by using MCData user information received in the ad hoc group standalone data request and compiled list of MCData users to be part of ad hoc group. The MCData server 105 assigns an MCData ad hoc group ID for the newly formed ad hoc group and optionally assigns the time to live value. The ad hoc group members can communicate in the ad hoc group until the time to live value has expired.

In step 3E9, the MCData server 105 of the primary MCData system considers the compiled list of MCData users in step 3E8 as implicitly affiliated to the ad hoc group.
i. If an emergency indicator is present in the received ad hoc group standalone data request and if the ad hoc group is not in the in-progress emergency state, the ad hoc group is considered to be in the in-progress emergency state until the SDS data transfer is completed; and
ii. If an imminent peril indicator is present in the received ad hoc group standalone data request and if the ad hoc group is not in the in-progress imminent peril state, the ad hoc group is considered to be in the in-progress imminent peril state until the SDS data transfer is completed.

Steps 3E10-3E14 are the same as steps 6 to 10 of clause 7.17.A.4.2 of TS 23.282.

FIG. 3F is a signal flow diagram illustrating an ad hoc group standalone SDS using end-to-end encryption involving multiple MCData systems, according to an embodiment. More specifically, FIG. 3F illustrates a scenario in which an MCData user is initiating an ad hoc group standalone SDS using a signaling control plane, with or without a disposition request.

Referring to FIG. 3F, it is assumed that the security aspects of sharing the user information between primary and partner MCData systems are governed as per the service provider agreement between them. In this case, it is also assumed that the partner MCData systems share their user information with the primary MCData system. MCData users on MCData clients 103B-103N belong to the primary MCData system and MCData users on MCData clients 106A-106N belong to the partner MCData system and are already registered for receiving the MCData service. The authorized MCData user at the MCData client 103A wants to invite MCData users at the MCData clients 103B-103N and 106A-106N from the ad hoc group for the ad hoc group standalone SDS. The MCData server 105 of the primary MCData system is where the authorized MCData user/dispatcher creates the ad hoc group. The number of ad hoc group members receiving the SDS data is within the configured limit. The preconfigured group identity and preconfigured group configuration (e.g., security related information) to be used for an ad hoc group have been preconfigured in the MCData client and other MCData users of ad hoc group have also received the relevant security related information.

In step 3F1, the user at the MCData client 103A initiates an SDS data transfer to multiple MCData users from primary and partner MCData systems.

Steps 3F2-3F5 are the same as steps 2 to 5 of clause 7.17.A.3.4 of TS 23.282.

In step 3F6a and 3F6b, the MCData server 105 of the primary MCData system 101 initiates an ad hoc group standalone data request (or a second data transfer request message) to each of the target MCData users in the primary MCData system and the partner MCData system. While sending the ad hoc group standalone data requests, the MCData server 105 of the primary MCData system may remove information elements that are not required to be conveyed to the target MCData clients (e.g., MCData ID list). The request may include the ad hoc group ID, a pre-configured group, if end-to-end encryption is required, and a time to live value for the ad hoc group.

In step 3F7a and 3F7b, if the payload is for MCData user consumption (e.g., is not application data, is not command instructions, etc.) then the MCData users of MCData clients 103B-103N and 106A-106N may be notified. Otherwise, if the payload is not for MCData user consumption, then the MCData users of MCData clients 103B-103N and 106A-106N shall not be notified.

The action taken when the payload contains application data or command instructions may be specified based on the contents of the payload. For example, payload content received by MCData clients 103B-103N and 106A-106N, which is addressed to a known local non-MCData application that is not yet running, shall cause the MCData clients 103B-103N and 106A-106N to start the local non-MCData application (i.e., remote start application) and pass the payload content to the just started application.

In step 3F8a and 3F8b, the receiving MCData clients send ad hoc group standalone data responses to the MCData server 105.

In step 3F9, the MCData server 105 of the primary MCData system 101 sends the ad hoc group standalone data response to the MCData client 103A through the signaling path to inform about a result of SDS data transfer, including any error (e.g., the ad hoc group standalone data request authorization failure). The response may include the ad hoc group ID, a pre-configured group, if end-to-end encryption is required, and a time to live value for the ad hoc group.

The primary MCData server 105 removes the ad hoc group information from the dynamic data once the time to live value has expired and thus the ad hoc group ceases to exist.

In step 3F10, if the MCData data disposition for delivery was requested by the user at the MCData client 103A, then the receiving MCData clients initiates an MCData data disposition notification for delivery report as described in steps 6 to 9 of clause 7.4.2.5.2 of TS 23.282.

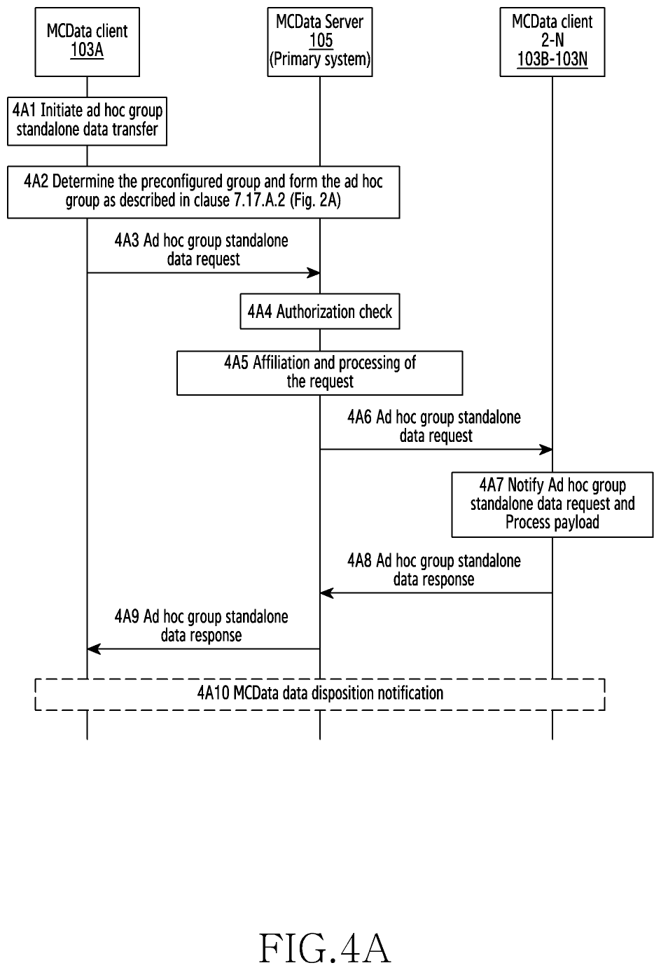

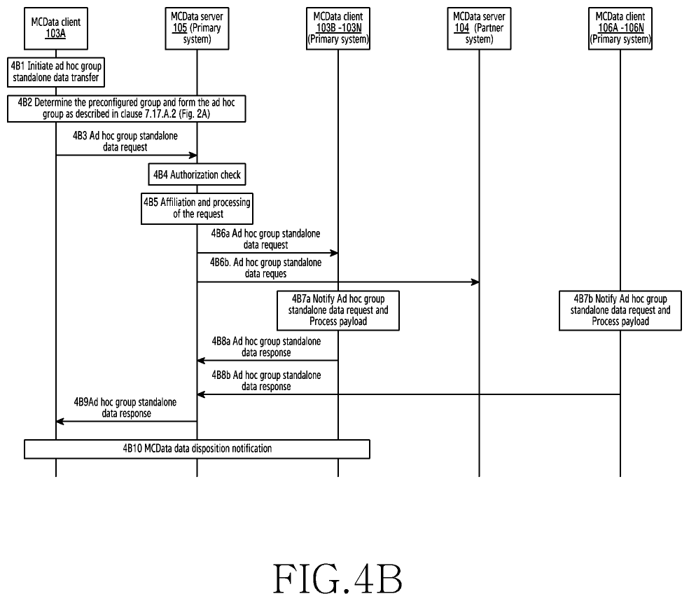

In FIGS. 4A and 4B, if end-to-end encryption for data transfer is required or not, the client will determine the ad hoc group and a preconfigured group for end-to-end encryption and then invoke the data transfer request. The determined ad hoc group and preconfigured group for end-to-end encryption are used in the data transfer request.

Table 9 describes an information flow for the ad hoc group standalone data request sent from an MCData client to an MCData server.

TABLE 9

| | Sta- | |
|---|---|---|
| Information element | tus | Description |
| MCData ID | M | The identity of the MCData user |
| | | sending data |
| Functional alias | O | The associated functional alias of the |
| | | MCData user sending data. |
| MCData ad hoc group | M | The MCData group ID to be associated |
| ID (see NOTE 1) | | with the ad hoc group standalone SDS |
| Preconfigured MCData | O | Group identity whose configuration is to |
| group ID (see NOTE | | be applied for ad hoc group standalone |
| 2) | | SDS. |
| Conversation Identifier | M | Identifies the conversation |
| Transaction Identifier | M | Identifies the MCData transaction |
| Emergency indicator | O | Indicates that the data request is for |
| (see NOTE 3) | | emergency ad hoc group standalone |
| | | SDS |
| Imminent peril | O | Indicates that the data request is for |
| indicator | | imminent peril ad hoc group standalone |
| (see NOTE 3) | | SDS |
| Disposition Type | O | Indicates the disposition type expected |
| | | from the receiver (i.e., delivered or read or |
| | | both) |
| MCData ID list | O | The specified MCData users who should |
| (see NOTE 4) | | send a disposition notification message. |
| Payload Destination | M | Indicates whether the payload is for |
| Type | | application consumption or MCData user |
| | | consumption |
| Location | O | Location of the Originating MCData user |
| | | sending the SDS |
| Application identifier | O | Identifies the application for which the |
| (see NOTE 5) | | payload is intended (e.g., text string, port |
| | | address, URI) |
| Application metadata | O | Implementation specific information that |
| container | | is communicated to the recipient |
| Payload | M | SDS content |

NOTE 1:
The MCData ad hoc group ID is determined prior to by using the Ad hoc group standalone data transfer request.
NOTE 2:
If end-to-end encryption is required, then this element is included, and the value is determined prior to by using the Ad hoc group standalone data transfer request.
NOTE 3:
If used, only one of these information elements shall be present.
NOTE 4:
If Disposition Type IE is not present, this IE shall not be present. If Disposition Type IE is present but this IE is not, which indicates that all receivers shall respond with disposition notification message.
NOTE 5:
The application identifier shall be included only if the payload destination type indicates that the SDS message is for application consumption.

FIGS. 4A and 4B are directed to determining an MCData ad hoc group ID and a preconfigured group identity of a preconfigured group from which the configurations are to be used (e.g., security related information) and an ad hoc group standalone data transfer procedure, with/without end-to-end encryption.

FIG. 4A is a signal flow diagram illustrating an ad hoc group standalone SDS using an MCData ad hoc group involving a single MCData system, according to an embodiment. More specifically, FIG. 4A illustrates a scenario in which an MCData user is initiating an ad hoc group standalone SDS using a signaling control plane, with or without disposition request.

Referring to FIG. 4A, it is assumed that the MCData users on MCData clients 103A-103N belong to the same MCData system and are already registered for receiving MCData service. The authorized MCData user at the MCData client 103A wants to invite MCData users of the ad hoc group for the ad hoc group standalone SDS. The number of ad hoc group members receiving the SDS data is within the configured limit. The preconfigured group identity and preconfigured group configuration (e.g., security related information) to be used for an ad hoc group have been preconfigured in the MCData client and other MCData users of ad hoc group have also received the relevant security related information.

In step 4A1, the user at the MCData client 103A initiates an SDS data transfer to multiple MCData users from the primary MCData system.

In step 4A2, the MCData client 103A determines the preconfigured group, if end-to-end encryption is required, and an ad hoc group by executing the procedures as described in the clause 7.17.A.2 of TS 23.282.

In step 4A3, the MCData client 103A sends an ad hoc group standalone data request to the MCData server 105. The request may include the MCData ad hoc group ID as determined in step 4A2, the conversation identifier for message thread indication, additional implementation specific information in the application metadata container, a disposition request if indicated by the user at MCData client 103A, and an associated functional alias of the user at MCData client 103A. If end-to-end encryption is required, the request may include the preconfigured MCData group ID as determined in step 4A2. If the end-to-end encryption is not required, then payload without encryption is included, and if the end-to-end encryption is required, then payload with encryption is included, based on the preconfigured MCData group ID as determined in step 4A2.

If the MCData user at the MCData client 103A initiates an emergency ad hoc group standalone SDS or the MCData emergency state is already set for the MCData client 103A (e.g., due to a previously triggered MCData emergency alert):
i. the ad hoc group standalone data request may include an emergency indicator;
ii. if the MCData emergency state is not set already, MCData client 103A sets its MCData emergency state. The MCData emergency state is retained until explicitly cancelled; and
iii. once an emergency SDS data transfer has been initiated, the ad hoc group is considered to be in an in-progress emergency state until the SDS data transfer is completed and/or the time to live value of the ad hoc group expires.

If the MCData user at MCData client 103A initiates an imminent peril ad hoc group standalone SDS:
i. the ad hoc group standalone data request may include an imminent peril indicator; and
ii. once an emergency SDS data transfer has been initiated, the ad hoc group is considered to be in an in-progress imminent peril state until the SDS data transfer is completed and the time to live value of ad hoc group expires.

In step 4A4, if the ad hoc group communication is supported, the MCData server 105 checks whether the MCData user at MCData client 103A is authorized to send the ad hoc group standalone data request. If not authorized, the MCData server 105 rejects the ad hoc group standalone data request in step 4A9.

The MCData server 105 checks whether any policy is to be asserted to limit certain types of message or content to certain members, e.g., to location or user privilege. The MCData server 105 also verifies whether the provided functional alias can be used and has been activated for the user.

In step 4A5, the MCData server 105 considers the ad hoc group members as implicitly affiliated to the ad hoc group.
i. If an emergency indicator is present in the received ad hoc group standalone data request and if the ad hoc group is not in the in-progress emergency state, the ad hoc group is considered to be in the in-progress emergency state until the SDS data transfer is completed and/or the time to live value of the ad hoc group expires; and
ii. If an imminent peril indicator is present in the received ad hoc group standalone data request and if the ad hoc group is not in the in-progress imminent peril state, the ad hoc group is considered to be in the in-progress imminent peril state until the SDS data transfer is completed and the time to live value of the ad hoc group expires.

In step 4A6, the MCData server 105 initiates an ad hoc group standalone data request to each of the target MCData users. While sending the Ad hoc group standalone data request, the MCData server 105 may remove information elements that are not required to be conveyed to the target MCData clients (e.g., MCData ID list). The request may include the ad hoc group ID, a pre-configured group, if end-to-end encryption is required, and a time to live value for the ad hoc group.

In step 4A7, if the payload is for MCData user consumption (e.g., is not application data, is not command instructions, etc.) then the MCData users of MCData clients 103B-103N may be notified. Otherwise, if the payload is not for MCData user consumption, then the MCData users of MCData clients 103B-103N shall not be notified.

The action taken when the payload contains application data or command instructions may be based on the contents of the payload. For example, payload content received by the MCData client 103B, which is addressed to a known local non-MCData application that is not yet running, shall cause the MCData client 103B to start the local non-MCData application (i.e., remote start application) and pass the payload content to the just started application.

In step 4A8, the receiving MCData clients send ad hoc group standalone data responses to the MCData server 105.

In step 4A9, the MCData server 105 sends the ad hoc group standalone data response to the MCData client 103A through the signaling path to inform about a result of SDS data transfer, including any error (e.g., the Ad hoc group standalone data request authorization failure). The response may include the ad hoc group ID, a pre-configured group, if end-to-end encryption is required, and a time to live value for the ad hoc group.

The primary MCData server 105 removes the ad hoc group information from the dynamic data once the time to live value has expired and thus the ad hoc group ceases to exist.

In step 4A10, if the MCData data disposition for delivery was requested by the user at the MCData client 103A, then the receiving MCData clients initiate an MCData data disposition notification for a delivery report as described in steps 6 to 9 of clause 7.4.2.5.2 of TS 23.282.

FIG. 4B is a signal flow diagram illustrating an ad hoc group standalone SDS using an MCData ad hoc group involving multiple MCData systems, according to an embodiment. More specifically, FIG. 4B illustrates a scenario in which an MCData user is initiating an ad hoc group standalone SDS using a signaling control plane, with or without disposition request.

Referring to FIG. 4B, it is assumed that the security aspects of sharing the user information between primary and partner MCData systems are governed as per the service provider agreement between them. In this case, it is also assumed that the partner MCData systems share their user information with the primary MCData system. The MCData users on MCData clients 103B-103N belong to the primary MCData system and MCData users on MCData clients 103A-103N belong to the partner MCData system and are already registered for receiving MCData service. The authorized MCData user at the MCData client 103A wants to invite MCData users at the MCData clients 103B-103N and 106A-106N from the ad hoc group for the ad hoc group standalone SDS. The MCData server 105 of the primary MCData system is where the authorized MCData user/dispatcher creates the ad hoc group. The number of ad hoc group members receiving the SDS data is within configured limit. The preconfigured group identity and preconfigured group configuration (e.g., security related information) to be used for an ad hoc group have been preconfigured in the MCData client and other MCData users of ad hoc group have also received the relevant security related information.

In step 4B1, the user at the MCData client 103A initiates an SDS data transfer to multiple MCData users from the primary and partner MCData systems.

Steps 4B2-4B5 are the same as steps 2 to 5 of clause 7.17.A.3.2 of TS 23.282.

In steps 4B6a and 4B6b, the MCData server 105 of the primary MCData system 101 initiates an ad hoc group standalone data request to each of the target MCData users in the primary MCData system and the partner MCData system. While sending the ad hoc group standalone data requests, the MCData server 105 of the primary MCData system 101 may remove information elements that are not required to be conveyed to the target MCData clients (e.g., MCData ID list). The request may include the ad hoc group ID, a pre-configured group, if end-to-end encryption is required, and a time to live value for the ad hoc group.

In steps 4B7a and 4B7b, if the payload is for MCData user consumption (e.g., is not application data, is not command instructions, etc.) then the MCData user of the MCData clients 103B-103N and 106A-106N may be notified. Otherwise, if the payload is not for MCData user consumption, then the MCData users of the MCData clients 103B-103N and 106A-106N shall not be notified.

The action taken when the payload contains application data or command instructions may be based on the contents of the payload. For example, payload content received by the MCData clients 103B-103N and 106A-106N, which is addressed to a known local non-MCData application that is not yet running, shall cause the MCData clients 103B-103N and 106A-106N to start the local non-MCData application (i.e., remote start application) and pass the payload content to the just started application.

In step 4B8a and 4B8b, the receiving MCData clients send ad hoc group standalone data responses to the MCData server 105.

In step 4B9, the MCData server 105 of the primary MCData system sends the ad hoc group standalone data response to the MCData client 103A through the signaling path to inform about a result of the SDS data transfer, including any error (e.g., the ad hoc group standalone data request authorization failure). The response may include the ad hoc group ID, a pre-configured group, if end-to-end encryption is required, and a time to live value for the ad hoc group.

The primary MCData server 105 removes the ad hoc group information from the dynamic data once the time to live value has expired and thus the ad hoc group ceases to exist.

In step 4B10, if the MCData data disposition for delivery was requested by the user at the MCData client 103A, then the receiving MCData clients initiate an MCData data disposition notification for a delivery report as described in steps 6 to 9 of clause 7.4.2.5.2 of TS 23.282.

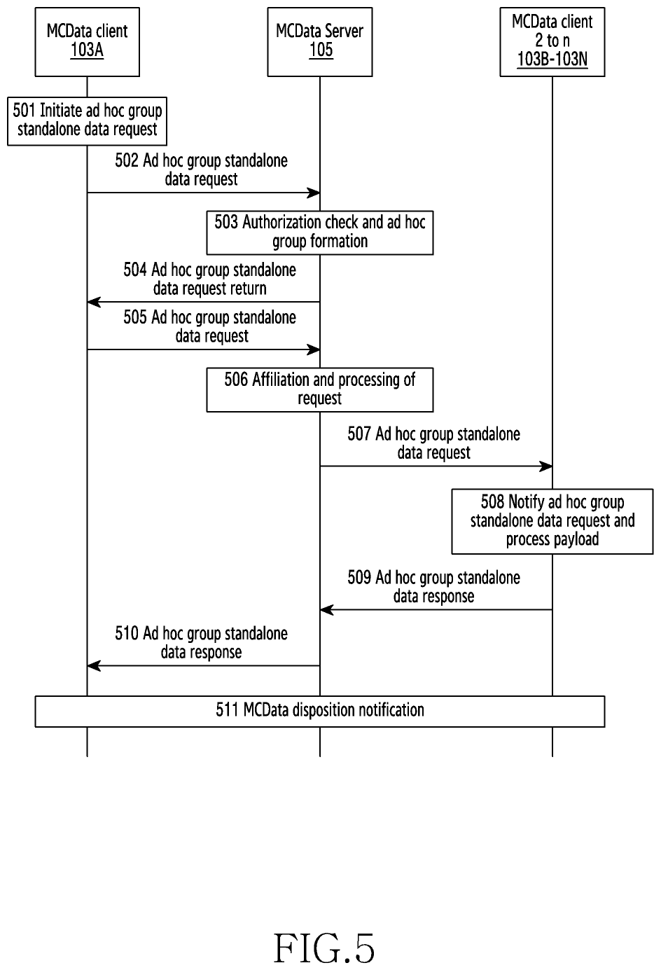

FIGS. 5-8 provide mechanisms for supporting an ad hoc group standalone SDS using a signaling control plane:
1. The initial request of the ad hoc group standalone SDS using a signaling control plane without the payload data may be used to determine the ad hoc group ID and pre-configured MCData group ID and the list of MCData users, if the criteria is specified.
2. Support for the ad hoc group standalone SDS using a signaling control plane based on the list of MCData users provided by the initiating MCData user or criteria may be used to determine the list of MCData users.
3. Support for one time determination of MCData users from partner MCData system if the partner MCData system is required to involve based on the criteria.
4. Support the disposition notification from ad hoc group MCData users.
5. Clearing of ad hoc group once the ad hoc group standalone SDS using signaling control plane completes SDS data transfer along with the local polices if anything defined.

The ad hoc group standalone SDS using a control plane may be used to transfer the SDS data by initiating an MCData user provided list or by an MCData server 105 determining the list of MCData user based on the criteria. If end-to-end encryption is required for the ad hoc group standalone SDS, the server will determine the appropriate pre-configured group which can be used by all the list of MCData users for securely receiving the SDS data.

Table 10 describes an information flow for an ad hoc group standalone data request sent from an MCData client to an MCData server.

TABLE 10

| | Sta- | |
|---|---|---|
| Information element | tus | Description |
| MCData ID | M | The identity of the MCData user |
| | | sending data |
| Functional alias | O | The associated functional alias of the |
| | | MCData user sending data. |
| MCData ad hoc group | O | The MCData group ID which is generated |
| ID (see NOTE 1) | | by the MCData user to be associated with |
| | | the ad hoc group standalone SDS |
| Encryption supported | O | Indicates whether this ad hoc group data |
| (see NOTE 2) | | transfer supports end-to-end encryption |
| MCData ID list | O | MCData IDs for the ad hoc group |
| (see NOTE 3, | | standalone SDS |
| NOTE 4) | | |
| Criteria for | O | Carries the details of criteria or |
| determining | | meaningful label identifying the criteria |
| the participants | | or the combination of both which will be |
| (see NOTE 4) | | used by the MCData server for |
| | | determining the list of MCData users e.g., |
| | | it can be a location based criteria to SDS |
| | | data transfer in a particular area |
| Conversation Identifier | M | Identifies the conversation |
| Transaction Identifier | M | Identifies the MCData transaction |
| Reply Identifier | O | Identifies the original MCData |
| | | transaction to which the current |
| | | transaction is a reply to |
| Emergency indicator | O | Indicates that the data request is for |
| (see NOTE 5) | | emergency ad hoc group standalone SDS |
| Alert indicator | O | Indicates whether an emergency alert is to |
| (see NOTE 6) | | be sent |
| Imminent peril | O | Indicates that the data request is for |
| indicator | | imminent peril ad hoc group standalone |
| (see NOTE 5) | | SDS |
| Disposition Type | O | Indicates the disposition type expected |
| | | from the receiver (i.e., delivered or read |
| | | or both) |
| MCData ID list | O | The specified MCData users who should |
| (see NOTE 7) | | send a disposition notification message. |
| Payload Destination | M | Indicates whether the payload is for |
| Type | | application consumption or MCData user |
| | | consumption |
| Location | O | Location of the Originating MCData user |
| | | sending the SDS |
| Application identifier | O | Identifies the application for which the |
| (see NOTE 8) | | payload is intended (e.g. text string, port |
| | | address, URI) |
| Application metadata | O | Implementation specific information that |
| container | | is communicated to the recipient |
| Payload | M | SDS content |

NOTE 1:
If this information element is not included, the MCData server assigns an MCData ad hoc group ID to be used for the ad hoc group standalone SDS. This information element is returned to the MCData user who is sending the data to use in the ad hoc group standalone SDS.
NOTE 2:
This information element is present and set to true only if the ad hoc group standalone SDS is encrypted. When the ad hoc group standalone SDS is initiated with list of MCData users provided by the initiator this acts as an indicator that subsequent requests follow targeting the individual MCData users and carrying the relevant key material. If this information element is set to false or not present, then the ad hoc group standalone SDS is unencrypted.
NOTE 3:
This element is included only when the ad hoc group standalone SDS initiating client sends the list of MCData users.
NOTE 4:
Only one of these information elements is present.
NOTE 5:
If used, only one of these information elements shall be present.
NOTE 6:
This information element may be present only when Emergency indicator is present.
NOTE 7:
If Disposition Type IE is not present, this IE shall not be present. If Disposition Type IE is present but this IE is not, which indicates that all receivers shall respond with disposition notification message.
NOTE 8:
The application identifier shall be included only if the payload destination type indicates that the SDS message is for application consumption.

Table 11 describes an information flow for an ad hoc group standalone data request sent from an MCData server to an MCData client.

TABLE 11

| Information | Sta- | |
|---|---|---|
| element | tus | Description |
| MCData ID | M | The identity of the MCData user sending |
| | | data |
| Functional alias | O | The associated functional alias of the |
| | | MCData user sending data. |
| MCData ad hoc | M | The MCData group ID associated with |
| group ID | | ad hoc group standalone SDS |
| Preconfigured | O | Group identity whose configuration is to be |
| MCData group ID | | applied for this ad hoc group standalone |
| | | SDS. |
| MCData ID | M | The identity of the MCData user towards |
| | | which the data is sent |
| Conversation | M | Identifies the conversation |
| Identifier | | |
| Transaction | M | Identifies the MCData transaction |
| Identifier | | |
| Reply Identifier | O | Identifies the original MCData transaction |
| | | to which the current transaction is a reply |
| | | to |
| Emergency | O | Indicates that the data request is for |
| indicator | | emergency ad hoc group standalone SDS |
| (see NOTE 1) | | |
| Alert indicator (see | O | Indicates whether an emergency alert is to |
| NOTE 2) | | be sent |
| Imminent peril | O | Indicates that the data request is for |
| indicator | | imminent peril ad hoc group standalone |
| (see NOTE 1) | | SDS |
| Disposition Type | O | Indicates the disposition type expected |
| | | from the receiver (i.e., delivered or read or |
| | | both) |
| MCData ID list | O | The specified MCData users who should |
| (see NOTE 4) | | send disposition notification message. |
| Payload | M | Indicates whether the payload is for |
| Destination Type | | application consumption or MCData user |
| | | consumption |
| Location | O | Location of the Originating MCData user |
| | | sending the SDS |
| Application | O | Identifies the application for which the |
| identifier (see | | payload is intended (e.g. text string, port |
| NOTE 3) | | address, URI) |
| Application | O | Implementation specific information that is |
| metadata container | | communicated to the recipient |
| Payload | M | SDS content |

NOTE 1:
If used, only one of these information elements shall be present.
NOTE 2:
This information element may be present only when Emergency indicator is present.
NOTE 3:
The application identifier shall be included only if the payload destination type indicates that the payload is for application consumption.
NOTE 4:
If Disposition Type IE is not present, this IE shall not be present. If Disposition Type IE is present but this IE is not, which indicates that all receivers shall respond with disposition notification message.

Table 12 describes an information flow of an ad hoc group standalone data request return from an MCData server to an MCData client. This response may be an intermediate response to provide the server assigned MCData ad hoc group ID.

TABLE 12

| | Sta- | |
|---|---|---|
| Information Element | tus | Description |
| MCData ID | M | The identity of the |
| | | MCData user sending |
| | | data |
| MCData ad hoc group | O | The MCData group ID to |
| ID | | be associated with the |
| | | ad hoc group standalone |
| | | SDS which is assigned |
| | | by the MCData server. |
| | | This information element |
| | | shall be present if the |
| | | authorization result is |
| | | success. |
| Preconfigured | O | Group identity whose |
| MCData group ID | | configuration is to be |
| | | applied for this ad hoc |
| | | group standalone SDS. |
| Authorization result | M | Indicate if authorization |
| | | is success or failure |

Table 13 describes the information flow of an ad hoc group standalone data response from an MCData server to an MCData client.

TABLE 13

| Information Element | Status | Description |
|---|---|---|
| MCData ID | M | The identity of the |
| | | MCData user sending |
| | | data |
| Functional alias | O | The associated functional |
| | | alias of the MCData user |
| | | sending data. |
| MCData ad hoc group | M | The MCData group ID |
| ID | | associated with the |
| | | ad hoc group standalone |
| | | SDS |
| Result | M | Result of the ad hoc |
| | | group standalone SDS |
| | | (success or failure) |

Table 14 describes an information flow of an ad hoc group standalone data get user list from an MCData server to another MCData server).

TABLE 14

| Information | | |
|---|---|---|
| element | Status | Description |
| MCData ad hoc | M | The MCData group ID |
| group ID | | associated with the ad hoc |
| | | group standalone SDS |
| | | Carries the details of |
| | | criteria or meaningful label |
| | | identifying the criteria or |
| | | the combination of both |
| Criteria for | | which will be used by the |
| determining the | M | MCData server for |
| participants | | determining the list of |
| | | MCData users e.g., it can |
| | | be a location based criteria |
| | | to SDS data transfer in a |
| | | particular area |

Table 15 describes an information flow of an ad hoc group standalone data get user list response from an MCData server to another MCData server.

TABLE 15

| Information | | |
|---|---|---|
| element | Status | Description |
| MCData ad hoc | M | The MCData group ID |
| | | associated with the ad hoc |
| group ID | | group standalone SDS |
| MCData ID list | M | List of MCData IDs meeting |
| | | the criteria specified in the |
| | | Ad hoc group standalone |
| | | data get user list |

### Ad Hoc Group Standalone SDS Using Signaling Control Plane Involving Single MCData System

In general, the initiation of an ad hoc group standalone SDS using a signaling control plane results in ad hoc group members from a single MCData system receiving the SDS data. The SDS payload data size is assumed to be below the configured maximum payload data size for SDS over the signaling control plane.

Procedure in which MCData User List Provided by the Initiator:

FIG. 5 is a signal flow diagram illustrating an ad hoc group standalone SDS using an MCData user list provided by an initiator involving a single MCData system, according to an embodiment. More specifically, FIG. 5 illustrates a scenario in which an MCData user is initiating ad hoc group standalone SDS using a signaling control plane, with or without a disposition request, along with the MCData user list provided by the initiating MCData user, to an ad hoc group.

### Pre-Conditions of FIG. 5:

1. MCData users on MCData clients 103A-103N belong to the same MCData system and are already registered for receiving MCData service.
2. The authorized MCData user at MCData client 103A wants to invite MCData users at the MCData clients 103B-103N for the ad hoc group standalone SDS.
3. The number of ad hoc group members receiving the SDS data is within the limit for non-pre-configured approach.
4. The preconfigured group identity and preconfigured group configuration (e.g. security related information) to be used for an ad hoc group have been preconfigured in the MCData client and other MCData users of ad hoc group have also received the relevant security related information.
5. MCData client 103A is aware of the MCData IDs of the ad hoc group members receiving the SDS data.

NOTE: Selection of MCData IDs of the ad hoc group members receiving the SDS data can be manual or from the user profile configuration data or by any other means. This is left for the implementation.

Referring to FIG. 5, in step 501, the user at the MCData client 103A initiates an SDS data transfer to multiple MCData users.

In step 502, the MCData client 103A sends an ad hoc group standalone data request to the MCData server 105. The Ad hoc group standalone data request includes list of MCData users as selected by the user at the MCData client 103A.

If end-to-end encryption is supported, an encryption supported information element may be set to true and a pre-configured MCData group whose configuration is to be applied is included, if known. The request may include a conversation ID for message thread indication, additional implementation specific information in the application metadata container, a disposition request if indicated by the user at MCData client 103A, and an associated functional alias of the user at the MCData client 103A. If the end-to-end encryption is not required, then the payload is included without encryption.

If the MCData user at the MCData client 103A initiates an emergency ad hoc group standalone SDS or the MCData emergency state is already set for the MCData client 103A (e.g., due to a previously triggered MCData emergency alert):
i) the ad hoc group standalone data request may include an emergency indicator;
ii) the ad hoc group standalone data request may set an alert indicator if configured to send an MCData emergency alert while initiating an ad hoc group standalone data request for the emergency SDS;
iii) if the MCData emergency state is not set already, MCData client 103A sets its MCData emergency state. The MCData emergency state is retained until explicitly cancelled; and
iv) once an emergency SDS data transfer has been initiated, the ad hoc group is considered to be in an in-progress emergency state until the SDS data transfer is completed.

If the MCData user at MCData client 103A initiates an imminent peril ad hoc group standalone SDS:
i) the ad hoc group standalone data request may include an imminent peril indicator; and
ii) once an emergency SDS data transfer has been initiated, the ad hoc group is considered to be in an in-progress imminent peril state until the SDS data transfer is completed.

In step 503, the MCData server 105 checks whether the MCData user at the MCData client 103A is authorized to send an ad hoc group standalone data request. If not authorized, the MCData server 105 rejects the ad hoc group standalone data request in step 504 and does not continue with the rest of the steps.

The MCData server 105 validates whether the number of MCData users provided in the request are within the configured limit before proceeding with the SDS data transfer. The MCData server 105 also checks whether any policy is to be asserted to limit certain types of message or content to certain members, e.g., to location or user privilege. The MCData server 105 also verifies whether the provided functional alias, if present, can be used and has been activated for the user.

The MCData server 105 forms the ad hoc group by using MCData user information received in step 502 and further determines the preconfigured group to be used for the configuration (e.g. security related information) of the ad hoc group based on the MCData users information received in step 502, if the preconfigured MCData group ID provided by the MCData client 103A is not acceptable or the preconfigured MCData group ID was not provided by the MCData client 103A.

The MCData server 105 assigns an MCData ad hoc group ID for the newly formed ad hoc group if the MCData ad hoc group ID created by the MCData client 103A is not acceptable or the MCData ad hoc group ID was not provided by the MCData client 103A.

In step 504, the MCData server 105 sends the ad hoc group standalone data request return message to the MCData client 103A, which may include the following:
i. The MCData ad hoc group ID generated by the MCData server 105 (when the ad hoc group standalone data request is authorized);
ii. The MCData group ID of the pre-configured group whose configuration is to be applied for this ad hoc group standalone SDS (when the ad hoc group standalone data request is authorized); and
iii. A result of whether the ad hoc group standalone data request is authorized or not.

If the ad hoc group standalone data request is not authorized, the MCData client 103A shall not proceed with the rest of the steps.

In step 505, the MCData client 103A re-sends an ad hoc group standalone data request to the MCData server 105 including the MCData ad hoc group ID generated by the MCData server 105 and the encrypted payload using pre-configured group returned by the MCData server 105.

NOTE 1: Step 504 and 505 are applicable if the end-to-end encryption is required for the ad hoc group standalone SDS.

In step 506, the MCData server 105 considers the list of MCData users provided in the request as implicitly affiliated to the ad hoc group.
i) If an emergency indicator is present in the received ad hoc group standalone data request and if the ad hoc group is not in the in-progress emergency state, the ad hoc group is considered to be in the in-progress emergency state until the SDS data transfer is completed; and
ii) If an imminent peril indicator is present in the received ad hoc group standalone data request and if the ad hoc group is not in the in-progress imminent peril state, the ad hoc group is considered to be in the in-progress imminent peril state until the SDS data transfer is completed.

In step 507, the MCData server 105 initiates an ad hoc group standalone data request to each of the MCData clients 103B-103N determined in step 502.

While sending the ad hoc group standalone data requests, the MCData server 105 may remove information elements that are not required to be conveyed to the target MCData clients (e.g. MCData ID list).

In step 508, if the payload is for MCData user consumption (e.g. is not application data, is not command instructions, etc.) then the MCData users of MCData clients 103B-103N may be notified. Otherwise, if the payload is not for MCData user consumption, then the MCData users of MCData clients 103B-103N shall not be notified.

The action taken when the payload contains application data or command instructions may be based on the contents of the payload. For example, payload content received by the MCData client 103B, which is addressed to a known local non-MCData application that is not yet running, shall cause the MCData client 103B to start the local non-MCData application (i.e., remote start application) and pass the payload content to the just started application.

In step 509, the receiving MCData clients 103B-103N send ad hoc group standalone data responses to the MCData server 105.

In step 510, the MCData server 105 sends the ad hoc group standalone data responses to MCData client 103A through the signaling path to inform about the successful SDS data transfer.

The primary MCData server 105 removes the ad hoc group information from the dynamic data and thus the ad hoc group ceases to exist.

In step 511, if the MCData data disposition for delivery was requested by the user at the MCData client 103A, then the receiving MCData clients 103B-103N initiate an MCData data disposition notification for a delivery report as described in steps S6 to S9 of clause 7.4.2.5.2 of TS 23.282.

Procedure in which MCData User List Provided by the MCData Server:

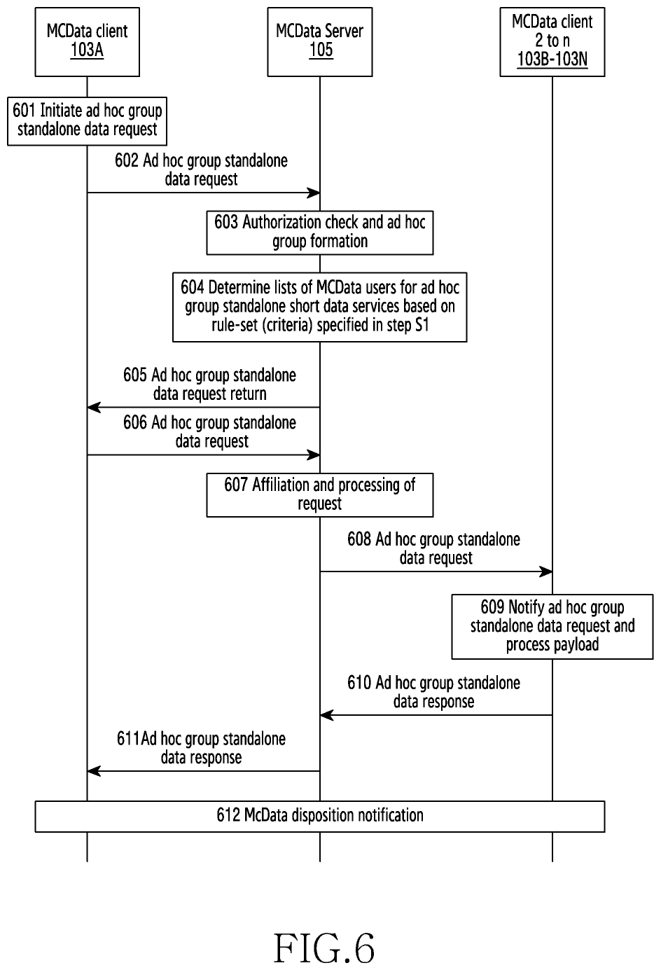

FIG. 6 is a signal flow diagram illustrating an ad hoc group standalone SDS using an MCData user list provided by an MCData server involving a single MCData system, according to an embodiment. More specifically, FIG. 6 illustrates a scenario in which an MCData user is initiating ad hoc group standalone SDS using a signaling control plane, with or without a disposition request, and the MCData user list is provided by the MCData server, to an ad hoc group.

### Pre-Conditions of FIG. 6:

1. MCData users on MCData clients 103B-103N belong to the same MCData system and are already registered for receiving MCData service.
2. The authorized MCData user at MCData client 103A wants to invite MCData users who are satisfying certain criteria for the ad hoc group standalone SDS.
3. The number of ad hoc group members receiving the SDS data is within the limit for non-pre-configured approach.
4. The preconfigured group identity and preconfigured group configuration (e.g. security related information) to be used for an ad hoc group have been preconfigured in the MCData clients and other MCData users of ad hoc group have also received the relevant security related information.

Referring to FIG. 5, in step 601, the user at the MCData client 103A initiates an SDS data transfer to multiple MCData users satisfying specific criteria.

In step 602, MCData client 103A sends an ad hoc group standalone data request to the MCData server 105. The ad hoc group standalone data request includes details of the criteria to be applied by the MCData server 105 for determining the list of MCData users. If end-to-end encryption is supported, an encryption supported information element may be set to true and pre-configured MCData group whose configuration is to be applied is included, if known. The request may include a conversation ID for message thread indication, additional implementation specific information in the application metadata container, a disposition request if indicated by the user at MCData client 103A, and an associated functional alias of the user at MCData client 103A.

If the end-to-end encryption is not required, then the payload without encryption is included.

If the MCData user at the MCData client 103A initiates an emergency ad hoc group standalone SDS or the MCData emergency state is already set for the MCData client 103A (e.g., due to a previously triggered MCData emergency alert):
i) the ad hoc group standalone data request may include an emergency indicator;
ii) the ad hoc group standalone data request shall may an alert indicator if configured to send an MCData emergency alert while initiating an ad hoc group standalone data request for the emergency SDS;
iii) if the MCData emergency state is not set already, the MCData client 103A sets its MCData emergency state. The MCData emergency state is retained until explicitly cancelled; and
iv) once an emergency SDS data transfer has been initiated, the ad hoc group is considered to be in an in-progress emergency state until the SDS data transfer is completed.

If the MCData user at MCData client 103A initiates an imminent peril ad hoc group standalone SDS:
i) the ad hoc group standalone data request may include an imminent peril indicator; and
ii) once an emergency SDS data transfer has been initiated, the ad hoc group is considered to be in an in-progress imminent peril state until the SDS data transfer is completed.

In step 603, the MCData server 105 checks whether the MCData user at the MCData client 103A is authorized to send an ad hoc group standalone data request. If not authorized, the MCData server 105 rejects the ad hoc group standalone data request in step 605 and does not continue with the rest of the steps.

The MCData server 105 checks whether any policy is to be asserted to limit certain types of message. The MCData server 105 also verifies whether the provided functional alias, if present, can be used and has been activated for the user.

The MCData server 105 forms the ad hoc group by using MCData user information received in step 602 and further determines the preconfigured group to be used for the configuration (e.g. security related information) of the ad hoc group based on the MCData user′ information received in step 602, if the preconfigured MCData group ID provided by the MCData client 103A is not acceptable or the preconfigured MCData group ID was not provided by the MCData client 103A. The MCData server 105 assigns an MCData ad hoc group ID for the newly formed ad hoc group if the MCData ad hoc group ID created by the MCData client 103A is not acceptable or the MCData ad hoc group ID was not provided by the MCData client 103A.

In step 604, the MCData server 105 determines the list of MCData users for an ad hoc group standalone SDS based on the information present in a criteria information element for determining the ad hoc group members. This information element may include criteria, an indicator identifying pre-defined criteria, or a combination of both.

NOTE 1: The content of the criteria information element, the details of the pre-defined criteria, and how the MCData server 105 determines the list of participants may vary according to implementation.

In step 605, the MCData server 105 sends the ad hoc group standalone data request return message, to MCData client 103A, which may include the following:
i. The MCData ad hoc group ID generated by the MCData server 105 (when the ad hoc group standalone data request is authorized);
ii. The MCData group ID of the pre-configured group whose configuration is to be applied for this ad hoc group standalone SDS (when the ad hoc group standalone data request is authorized); and
iii. A result of whether the ad hoc group standalone data request is authorized or not.

If the ad hoc group standalone data request is not authorized, the MCData client 103A shall not proceed with the rest of the steps.

In step 606, the MCData client 103A re-sends an ad hoc group standalone data request to the MCData server 105 including the MCData ad hoc group ID generated by the MCData server 105 and the encrypted payload using pre-configured group returned by the MCData server 105.

NOTE 2: Steps 604 and 606 are applicable if the end-to-end encryption is required for the ad hoc group standalone SDS.

In step 607, the MCData server 105 considers the list of MCData users determined in step 605 as implicitly affiliated to the ad hoc group.
i) If an emergency indicator is present in the received ad hoc group standalone data request and if the ad hoc group is not in the in-progress emergency state, the ad hoc group is considered to be in the in-progress emergency state until the SDS data transfer is completed; and
ii) If an imminent peril indicator is present in the received ad hoc group standalone data request and if the ad hoc group is not in the in-progress imminent peril state, the ad hoc group is considered to be in the in-progress imminent peril state until the SDS data transfer is completed.

In step 608, the MCData server 105 initiates an ad hoc group standalone data request to each MCData client determined in step 605.

While sending the ad hoc group standalone data requests, the MCData server 105 may remove information elements that are not required to be conveyed to the target MCData clients (e.g. MCData ID list).

Steps 609-612 are the same as the above-described procedure in which the MCData user list is provided by the initiator (subclause 7.17.4.A.2).

### Ad Hoc Group Standalone SDS Using a Signaling Control Plane Involving Multiple MCData System

The initiation of an ad hoc group standalone SDS using a signaling control plane results in ad hoc group members from multiple MCData systems receiving the SDS data. The SDS payload data size is assumed to be below the configured maximum payload data size for SDS over signaling control plane.

Procedure in which MCData User List Provided by the Initiator:

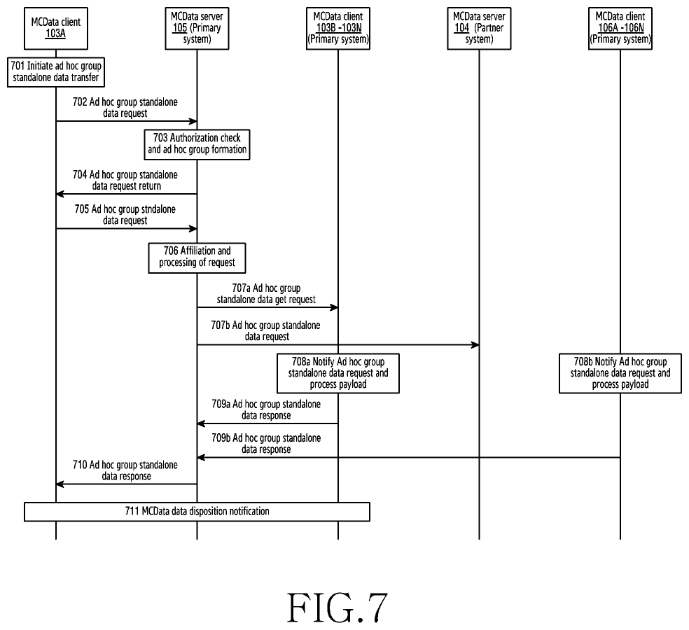

FIG. 7 is a signal flow diagram illustrating an ad hoc group standalone SDS using an MCData user list provided by an initiator involving multiple MCData systems, according to an embodiment. More specifically, FIG. 7 illustrates as scenario in which an MCData user is initiating ad hoc group standalone SDS using a signaling control plane, with or without a disposition request, along with the MCData user list provided by the initiating MCData user, to an ad hoc group.

### Pre-Conditions of FIG. 7:

1. The security aspects of sharing the user information between primary and partner MCData systems are governed as per the service provider agreement between them. In this case, it is assumed that the partner MCData systems share their user information with the primary MCData system.
2. MCData users on MCData clients 103B-103N belong to the primary MCData system and MCData users on MCData clients 106A-10-6N belong to the partner MCData system and are already registered for receiving MCData service.
3. The authorized MCData user at MCData client 103A wants to invite MCData users at MCData clients 103B-103N and 106A-106N for the ad hoc group standalone SDS.
4. The MCData server 105 of the primary MCData system is where the authorized MCData user/dispatcher creates the ad hoc group.
5. The number of ad hoc group members receiving the SDS data is within the limit for non-pre-configured approach.
6. The preconfigured group identity and preconfigured group configuration (e.g. security related information) to be used for an ad hoc group have been preconfigured in the MCData client and other MCData users of ad hoc group have also received the relevant security related information.
7. MCData client 103A is aware of the MCData IDs of the ad hoc group members receiving the SDS data.

NOTE: Selection of MCData IDs of the ad hoc group members receiving the SDS data can be manual or from the user profile configuration data or by any other means. This is left for the implementation.

Referring to FIG. 7, in step 701, the user at the MCData client 103A initiates an SDS data transfer to multiple MCData users from primary and partner MCData systems.

Steps 702-706 are the same as steps 602 to 606 of the above procedure (subclause 7.17.4.A.2).

In steps 707a and 707b, the MCData server 105 of the primary MCData system initiates an ad hoc group standalone data request to each of the MCData clients 103B-103N determined in step 702 in the primary MCData system and the partner MCData system.

While sending the ad hoc group standalone data requests, the MCData server 105 of the primary MCData system may remove information elements that are not required to be conveyed to the target MCData clients (e.g. MCData ID list).

In steps 708a and 708b, when the payload is for MCData user consumption (e.g. is not application data, is not command instructions, etc.) then the MCData users of the MCData clients 103B-103N and 106A-106N may be notified. Otherwise, if the payload is not for MCData user consumption, then the MCData users of the MCData clients 103B-103N and 106A-106N shall not be notified.

The action taken when the payload contains application data or command instructions may be based on the contents of the payload. For example, payload content received by the MCData clients 103B-103N and 106A-106N, which is addressed to a known local non-MCData application that is not yet running, shall cause the clients 103B-103N and 106A-106N to start the local non-MCData application (i.e., remote start application) and pass the payload content to the just started application.

In steps 709a and 709b, the receiving MCData clients send ad hoc group standalone data responses to the MCData server 105.

In step 710, the MCData server 105 of the primary MCData system sends the ad hoc group standalone data responses to the MCData client 1 103A through the signaling path to inform about a successful SDS data transfer.

The primary MCData server 105 removes the ad hoc group information from the dynamic data and thus the ad hoc group ceases to exist.

In step 711, when the MCData data disposition for a delivery was requested by the user at MCData client 103A, then the receiving MCData clients initiates an MCData data disposition notification for a delivery report as described in steps 6 to 9 of clause 7.4.2.5.2 of TS 23.282.

Procedure in which MCData User List Provided by the MCData Server:

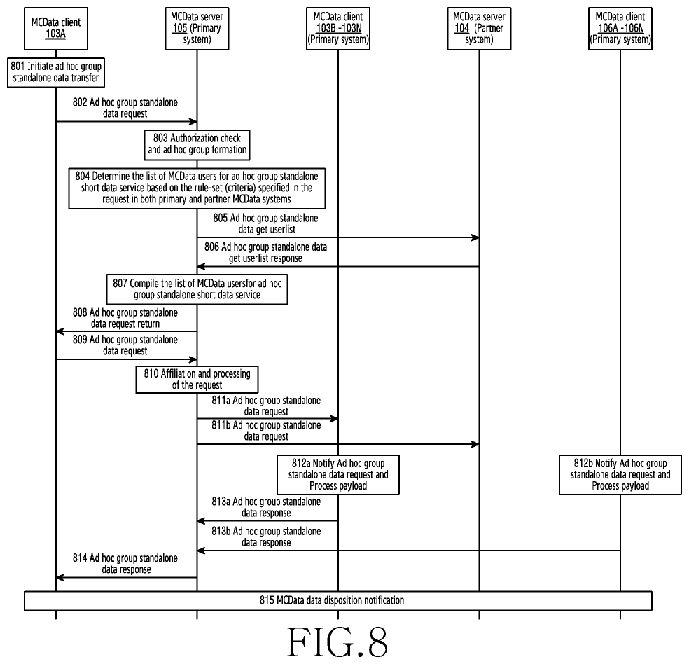

FIG. 8 is a signal flow diagram illustrating an ad hoc group standalone SDS using an MCData user list provided by an MCData server involving multiple MCData systems, according to an embodiment. More specifically, FIG. 8 illustrates a scenario in which an MCData user is initiating ad hoc group standalone SDS using a signaling control plane, with or without a disposition request, and the MCData user list is provided by the MCData server of the primary MCData system, to an ad hoc group.

### Pre-Conditions of FIG. 8:

1. The security aspects of sharing the user information between primary and partner MCData systems are governed as per the service provider agreement between them. In this case, it is assumed that the partner MCData systems share their user information with the primary MCData system.
2. MCData users on MCData clients 103B to 103N belong to the primary MCData system and MCData users on MCData clients 106A to 106N belong to the partner MCData system and are already registered for receiving MCData service.
3. The authorized MCData user at MCData client 103A wants to invite MCData users that satisfy certain criteria for the ad hoc group standalone SDS.
4. The MCData server of the primary MCData system is where the authorized MCData user/dispatcher creates the ad hoc group.
5. The number of ad hoc group members receiving the SDS data is within the limit for a non-pre-configured approach.
6. The preconfigured group identity and preconfigured group configuration (e.g. security related information) to be used for an ad hoc group have been preconfigured in the MCData client and other MCData users of ad hoc group have also received the relevant security related information.

Referring to FIG. 8, in step 801, the user at MCData client 103A initiates an SDS data transfer to multiple MCData users from primary and partner MCData systems satisfying specific criteria.

In step 802, the MCData client 103A sends an ad hoc group standalone data request to the MCData server 105 of the primary MCData system. The ad hoc group standalone data request includes details of the criteria to be applied by the MCData server 105 for determining the list of MCData users.

If end-to-end encryption is supported, an encryption supported information element may be set to true and a pre-configured MCData group whose configuration is to be applied is included, if known.

The request may include a conversation ID for message thread indication, additional implementation specific information in the application metadata container, a disposition request if indicated by the user at MCData client 103A, and an associated functional alias of the user at MCData client 103A.

If the end-to-end encryption is not required, then the payload without encryption is included.

If the MCData user at the MCData client 103A initiates an emergency ad hoc group standalone SDS or the MCData emergency state is already set for the MCData client 103A (e.g., due to a previously triggered MCData emergency alert):
i the ad hoc group standalone data request may include an emergency indicator;
ii. the ad hoc group standalone data request may set an alert indicator if configured to send an MCData emergency alert while initiating an Ad hoc group standalone data request for the emergency SDS;
iii. if the MCData emergency state is not set already, the MCData client 103A sets its MCData emergency state. The MCData emergency state is retained until explicitly cancelled; and
iv. once an emergency SDS data transfer has been initiated, the ad hoc group is considered to be in an in-progress emergency state until the SDS data transfer is completed.

If the MCData user at MCData client 103A initiates an imminent peril ad hoc group standalone SDS:
i. the ad hoc group standalone data request may include an imminent peril indicator; and
ii. once an emergency SDS data transfer has been initiated, the ad hoc group is considered to be in an in-progress imminent peril state until the SDS data transfer is completed.

In step 803, the MCData server 105 of the primary MCData system checks whether the MCData user at the MCData client 103A is authorized to send an ad hoc group standalone data request. If not authorized, the MCData server 105 rejects the ad hoc group standalone data request in step 805 and does not continue with the rest of the steps.

The MCData server 105 of the primary MCData system checks whether any policy is to be asserted to limit certain types of message. The MCData server 105 of the primary MCData system also verifies whether the provided functional alias, if present, can be used and has been activated for the user.

The MCData server 105 of the primary MCData system forms the ad hoc group by using MCData user information received in step 802 and further determines the preconfigured group to be used for the configuration (e.g. security related information) of the ad hoc group based on the MCData user information received in step 802, if the preconfigured MCData group ID provided by the MCData client 103A is not acceptable or the preconfigured MCData group ID was not provided by the MCData client 103A.

The MCData server 105 of the primary MCData system assigns an MCData ad hoc group ID for the newly formed ad hoc group if the MCData ad hoc group ID created by the MCData client 103A is not acceptable or the MCData ad hoc group ID was not provided by the MCData client 103A.

In step 804, the MCData server 105 of the primary MCData system determines the list of MCData users for an ad hoc group standalone SDS from the primary MCData system and determines the partner MCData system to be involved in the ad hoc group standalone SDS based on the information present in a criteria information element for determining the ad hoc group members. The criteria information element may include criteria, an indicator identifying pre-defined criteria, or a combination of both.

NOTE: The content of the criteria information element, the details of the pre-defined criteria, and how their MCData server 105 determines the list of participants may vary according to implementation.

In step 805, the MCData server 105 of the primary MCData system involves the partner MCData system based on the agreement and based on the criteria for determining the list of MCData users, it sends the ad hoc group standalone data get user list request to the MCData server 104 of partner MCData system. This request may carry the criteria specified in step 802.

In step 806, the MCData server 104 of the partner MCData system evaluates the criteria and determines the list of MCData users satisfying the criteria and sends the response containing the list of MCData users satisfying the criteria. The MCData server 104 of partner MCData system may apply local policies, if any, while determining the participants satisfying the criteria. The determination of list of MCData users may be performed only once.

In step 807, the MCData server 105 of the primary MCData system compiles the list of MCData users for ad hoc group standalone SDS including the MCData users from both primary and partner MCData system.

In step 808, the MCData server 105 of the primary MCData system sends the ad hoc group standalone data request return message to the MCData client 103A. The ad hoc group standalone data request return message may include the following:
i. The MCData ad hoc group ID generated by the MCData server 105 of the primary MCData system (when the ad hoc group standalone data request is authorized);
ii. The MCData group ID of the pre-configured group whose configuration is to be applied for this ad hoc group standalone SDS (when the Ad hoc group standalone data request is authorized); and
iii. A result of whether the ad hoc group standalone data request is authorized or not.

If the ad hoc group standalone data request is not authorized, the MCData client 103A shall not proceed with the rest of the steps.

In step 809, the MCData client 103A re-sends an ad hoc group standalone data request to the MCData server 105 of the primary MCData system including the MCData ad hoc group ID generated by the MCData server 105 of the primary MCData system and the encrypted payload using a pre-configured group returned by the MCData server 105 of the primary MCData system.

NOTE: Steps 808 and 809 are applicable if the end-to-end encryption is required for the ad hoc group standalone SDS.

In step 810, the MCData server 105 of the primary MCData system considers the compiled list of MCData users in step 807 as implicitly affiliated to the ad hoc group.
i. If an emergency indicator is present in the received ad hoc group standalone data request and if the ad hoc group is not in the in-progress emergency state, the ad hoc group is considered to be in the in-progress emergency state until the SDS data transfer is completed; and
ii. If an imminent peril indicator is present in the received ad hoc group standalone data request and if the ad hoc group is not in the in-progress imminent peril state, the ad hoc group is considered to be in the in-progress imminent peril state until the SDS data transfer is completed.

Steps 811-815 are the same steps as steps 707 to 711 of the above procedure in which the MCData user list provided by the initiator, which involves multiple MCData systems (subclause 7.17.4.B.2).

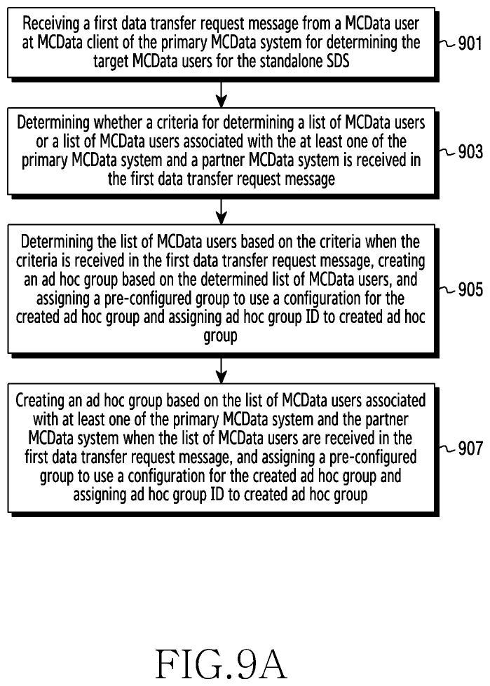

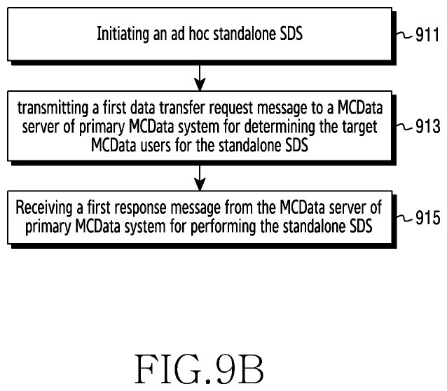

FIG. 9A is a flow chart illustrating a method for supporting an ad hoc group standalone SDS in an MCData service by an MCData server of an MCData primary system, according to an embodiment.

Referring to FIG. 9A, in step 901, the MCData server of the MCData primary system receives the first data transfer request message from an MCData user at an MCData client of the primary MCData system for determining target MCData users for the standalone SDS.

In step 903, the MCData server of the MCData primary system determines whether a criteria for determining a list of MCData users or a list of MCData users associated with the at least one of the primary MCData system and a partner MCData system is received in the first data transfer request message.

In step 905, the MCData server of the MCData primary system determines the list of MCData users based on the criteria when the criteria is received in the first data transfer request message. Further, the ad hoc group is created based on the determined list of MCData users. Further, a pre-configured group is assigned to use a configuration for the created ad hoc group and also assigns the ad hoc group ID to created ad hoc group.

In step 907, the MCData server of the MCData primary system creates ad hoc group based on the list of MCData users associated with at least one of the primary MCData system or the partner MCData system, when the list of MCData users are received in the first data transfer request message. Further, the pre-configured group is assigned to use the configuration for the created ad hoc group and also assigns the ad hoc group ID to created ad hoc group.

FIG. 9B is a flow chart illustrating a method for supporting an ad hoc group standalone SDS in an MCData service by an MCData client of an MCData primary system, according to an embodiment.

Referring to FIG. 9B, in step 911, the MCData user at the MCData client of the primary MCData system initiates an ad hoc standalone SDS.

In step 913, the MCData user at the MCData client transmits the first data transfer request message to an MCData server of the primary MCData system for determining target MCData users for the standalone SDS.

In step 915, MCData user at the MCData client of the primary MCData system receives the first response message from the MCData server of primary MCData system for performing the standalone SDS.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments.

Additionally, the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method for supporting an ad hoc group standalone short data service (SDS) in a mission critical data (MCData) service, the method comprising:
receiving, by an MCData server of a primary MCData system, a first data transfer request message from an MCData user at an MCData client of the primary MCData system for determining target MCData users for the ad hoc group standalone SDS;
determining, by the MCData server of the primary MCData system, whether a criteria for determining a list of MCData users or a list of MCData users associated with the at least one of the primary MCData system or a partner MCData system is received in the first data transfer request message;
in response to determining that the criteria for determining the list of the MCData users is received in the first data transfer request message, determining, by the MCData server, the list of MCData users based on the criteria, and creating an ad hoc group based on the determined list of the MCData users;
in response to determining that the list of the MCData users associated with the at least one of the primary MCData system or the partner MCData system is received in the first data transfer request message, creating, by the MCData server, the ad hoc group based on the list of the MCData users associated with the at least one of the primary MCData system or the partner MCData system;
assigning a pre-configured group to use a configuration for the ad hoc group; and
assigning an ad hoc group identifier (ID) to the ad hoc group.

2. The method of claim 1, further comprising transmitting, by the MCData server of the primary MCData system, a first response message to the MCData user at the MCData client of the primary MCData system for performing the ad hoc group standalone SDS.

3. The method of claim 1, wherein creating the ad hoc group based on the criteria for determining the list of MCData users comprises:
receiving, by the MCData server of the primary MCData system, a list of MCData users that meet the criteria from MCData servers of partner MCData system; and
creating, by the MCData server of the primary MCData system, the ad hoc group by including the list of the MCData users received from the MCData servers of the partner MCData system.

4. The method of claim 3, wherein receiving the list of the MCData users that meet the criteria from the MCData servers of the partner MCData system comprises:
transmitting, by the MCData server of the primary MCData system, a get user list request message to the MCData servers of the partner MCData system for fetching the list of the MCData users that meet the criteria; and
receiving, by the MCData server of the primary MCData system, a get user list response message including the list of the MCData users that meet the criteria specified in the get user list request message.

5. The method of claim 4, wherein the get user list request message comprises at least one of the ad hoc group ID of the ad hoc group or the criteria for determining the ad hoc group members.

6. The method of claim 4, wherein the get user list response message comprises the ad hoc group ID of the ad hoc group and the MCData ID list of the MCData user at an MCData client associated with the MCData server in the partner MCData system.

7. The method of claim 1, wherein the first data transfer response message comprises at least one of an MCData ID of the MCData user at the MCData client that initiated the first data transfer request message, an ad hoc group ID of the ad hoc group, a group ID of preconfigured group, or a result of the first data transfer request message.

8. A method for supporting an ad hoc group standalone short data service (SDS) in a mission critical data (MCData) service, the method comprising:
initiating, by an MCData user at an MCData client of a primary MCData system, the ad hoc group standalone SDS;
transmitting, by the MCData user at the MCData client of the primary MCData system, a first data transfer request message to an MCData server of the primary MCData system for determining target MCData users for the ad hoc group standalone SDS; and
receiving, by the MCData client of the primary MCData system, a first response message from the MCData server of the primary MCData system for performing the ad hoc group standalone SDS.

9. The method of claim 8, wherein the first data transfer request message comprises at least one of an MCData identifier (ID) of the MCData user at the MCData client initiating the first data transfer request message, a functional alias of the MCData user initiating the first data transfer request message, or an indication of whether end-to-end encryption is required for the ad hoc group standalone SDS, and
wherein the first data transfer request message further comprises at least one of:
an MCData ID list of the MCData users associated with at least one of the primary MCData system or a partner MCData system for creating the ad hoc group,
criteria for determining the ad hoc group members of at least one of the primary MCData system or the partner MCData system for creating the ad hoc group, or
an emergency indicator for indicating whether the first data transfer request message is for an emergency standalone SDS, an imminent peril indicator for indicating whether the first data transfer request message is for imminent peril, and an application ID for which a data payload is intended.

10. The method of claim 8, wherein the first data transfer response message comprises at least one of an MCData identifier (ID) of the MCData user at the MCData client that initiated the first data transfer request message, an ad hoc group ID of the ad hoc group, a group ID of preconfigured group, or a result of the first data transfer request message.

11. The method of claim 8, further comprising:
transmitting, by an MCData user at the MCData client of the primary MCData system, a second data transfer request message to the MCData server of the primary MCData system for performing the ad hoc group standalone SDS; and
receiving, by the MCData user at the MCData client of the primary MCData system, a second data transfer response message from the MCData server of the primary MCData system,
wherein the second data transfer response message indicates a completion of the ad hoc group standalone SDS.

12. A mission critical data (MCData) server of a primary MCData system for supporting an ad hoc group standalone short data service (SDS) in an MCData service, the MCData server comprising:
a processor; and
an SDS controller configured to:
receive a first data transfer request message from an MCData user at an MCData client of the primary MCData system for determining target MCData users for the ad hoc group standalone SDS,
determine whether a criteria for determining a list of MCData users or a list of MCData users associated with the at least one of the primary MCData system or a partner MCData system is received in the first data transfer request message,
in response to determining that the criteria for determining the list of the MCData users is received in the first data transfer request message, determine the list of MCData users based on the criteria, and create an ad hoc group based on the determined list of the MCData users,
in response to determining that the list of the MCData users associated with the at least one of the primary MCData system or the partner MCData system is received in the first data transfer request message, create the ad hoc group based on the list of the MCData users associated with the at least one of the primary MCData system or the partner MCData system,
assign a pre-configured group to use a configuration for the ad hoc group, and
assign an ad hoc group identifier (ID) to the ad hoc group.

13. The MCData server of claim 12, wherein the SDS controller is further configured to:
transmit a first response message to the MCData user at the MCData client of the primary MCData system for performing the ad hoc group standalone SDS.

14. The MCData server of claim 12, wherein to create the ad hoc group based on the criteria for determining the list of MCData users, the SDS controller is further configured to:
receive a list of MCData users that meet the criteria from MCData servers of the partner MCData system, and
create the ad hoc group by including the list of the MCData users received from the MCData servers of the partner MCData system.

15. The MCData server of claim 14, wherein to receive the list of the MCData users that meet the criteria from the MCData servers of the partner MCData system, the SDS controller is further configured to:
transmit a get user list request message to the MCData servers of the partner MCData system for fetching the list of the MCData users that meet the criteria, and
receive a get user list response message including the list of the MCData users that meet the criteria specified in the get user list request message.

16. The MCData server of claim 15, wherein the get user list request message comprises at least one of the ad hoc group ID of the ad hoc group or the criteria for determining the ad hoc group members.

17. The MCData server of claim 12, wherein the first data transfer response message comprises at least one of an MCData ID of the MCData user at the MCData client that initiated the first data transfer request message, an ad hoc group ID of the ad hoc group, a group ID of preconfigured group, or a result of the first data transfer request message.

18. A mission critical data (MCData) client of a primary MCData system for supporting an ad hoc group standalone short data service (SDS) in an MCData service, the MCData client comprising:
a processor; and
an SDS controller configured to:
initiate the ad hoc group standalone SDS,
transmit a first data transfer request message to an MCData server of the primary MCData system for determining target MCData users for the ad hoc group standalone SDS, and
receive a first response message from the MCData server of the primary MCData system for performing the ad hoc group standalone SDS.

19. The MCData client of claim 18, wherein the first data transfer request message comprises at least one of an MCData identifier (ID) of the MCData user at the MCData client initiating the first data transfer request message, a functional alias of the MCData user initiating the first data transfer request message, or an indication of whether end-to-end encryption is required for the ad hoc group standalone SDS, and
wherein the first data transfer request message further comprises at least one of:
an MCData ID list of the MCData users associated with at least one of the primary MCData system or a partner MCData system for creating the ad hoc group,
criteria for determining the ad hoc group members of at least one of the primary MCData system or the partner MCData system for creating the ad hoc group, or
an emergency indicator for indicating whether the first data transfer request message is for an emergency standalone SDS, an imminent peril indicator for indicating whether the first data transfer request message is for imminent peril, and an application ID for which a data payload is intended.

20. The MCData client of claim 18, wherein the first data transfer response message comprises at least one of an MCData identifier (ID) of the MCData user at the MCData client that initiated the first data transfer request message, an ad hoc group ID of the ad hoc group, a group ID of preconfigured group, or a result of the first data transfer request message.
